(19) United States
(12) Patent Application Publication
(10) Pub. No.: US 2025/0306662 A1
(43) Pub. Date: Oct. 2, 2025

(54) INFORMATION PROCESSING SYSTEM, NON-TRANSITORY COMPUTER-READABLE STORAGE MEDIUM, AND METHOD

(71) Applicant: FUJIFILM Business Innovation Corp., Tokyo (JP)

(72) Inventors: Koji UDAGAWA, Kanagawa (JP); Shun IDA, Kanagawa (JP); Masahito SHIKATA, Kanagawa (JP); Kazuhiko NARUSHIMA, Kanagawa (JP); Hidenori HORIE, Kanagawa (JP); Kazuya SUZUKI, Kanagawa (JP); Masayoshi MIKI, Kanagawa (JP); Yukio KONTANI, Kanagawa (JP)

(73) Assignee: FUJIFILM Business Innovation Corp., Tokyo (JP)

(21) Appl. No.: 18/807,600

(22) Filed: Aug. 16, 2024

(30) Foreign Application Priority Data
Mar. 26, 2024 (JP) 2024-049193

(51) Int. Cl. G06F 1/3231; H04N 1/00

(52) U.S. Cl. CPC G06F 1/3231; H04N 1/00381; H04N 1/00896

(57) ABSTRACT

An information processing system includes a processor for an apparatus having a plurality of modes having different times until execution of a process is ready, the processor being configured to: determine a mode that is to be recorded in a history as a mode at a time of execution of a process, the determining being performed based on a mode at the time of the apparatus's execution of the process and whether the process is performed based on a human detecting sensor's detection of a user; record the determined mode in the history; and output a set value of a shift time elapsing until the apparatus shifts to a mode in which a time until execution of a process is ready is longer than in another mode among the plurality of modes, the outputting being performed based on a count of processes performed in a specific mode, the count of processes being obtained based on the history.

### CROSS-REFERENCE TO RELATED APPLICATIONS

This application is based on and claims priority under 35 USC 119 from Japanese Patent Application No. 2024-049193 filed Mar. 26, 2024.

### BACKGROUND

### (i) Technical Field

The present disclosure relates to an information processing system, a non-transitory computer-readable storage medium, and a method.

### (ii) Related Art

There is known an apparatus having a power-saving function.

Japanese Unexamined Patent Application Publication (Translation of PCT Application) No. 2014-502929 describes a system providing a time-out value for an apparatus such as a printer.

There is also known an image processing apparatus that returns from a power saving mode to a normal operation mode when a human detecting sensor detects a person approaching the image processing apparatus.

For example, Japanese Unexamined Patent Application Publication No. 2012-114499 discloses an image processing apparatus (for example, a multifunction device) including a first sensor such as a pyroelectric sensor that detects a moving object and a second sensor such as a reflective sensor that detects an object within a detection distance shorter than that of the first sensor. This image processing apparatus determines whether a detected object (for example, a person) is a user who operates the image processing apparatus based on a combination of detection results of the two sensors. In accordance with the determination result, the image processing apparatus shifts from a power saving mode to a power supply mode in which execution of printing or the like is ready.

### SUMMARY

A known apparatus has multiple modes having different times elapsing until execution of a process is ready. The volume of processes performed by an apparatus and the time intervals of the processes may be different depending on each period, such as each day or each week. Therefore, the power-saving effect may be reduced if the apparatus has a constant shift time elapsing until a shift to a mode, among the modes, in which a time until execution of a process is ready is longer than that in another mode.

Aspects of non-limiting embodiments of the present disclosure relate to suppression of reduction of the power-saving effect compared with the case in which an apparatus has a constant shift time elapsing until a shift to a mode, among multiple modes, in which a time until execution of a process is ready is longer than that in another mode.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor for an apparatus having a plurality of modes having different times until execution of a process is ready, the processor being configured to: determine a mode that is to be recorded in a history as a mode at a time of execution of a process, the determining being performed based on a mode at the time of the apparatus's execution of the process and whether the process is performed based on a human detecting sensor's detection of a user; record the determined mode in the history; and output a set value of a shift time elapsing until the apparatus shifts to a mode in which a time until execution of a process is ready is longer than in another mode among the plurality of modes, the outputting being performed based on a count of processes performed in a specific mode, the count of processes being obtained based on the history.

### BRIEF DESCRIPTION OF THE DRAWINGS

Exemplary embodiments of the present disclosure will be described in detail based on the following figures, wherein:

FIG. 1 is a block diagram illustrating the hardware configuration of an image forming apparatus according to a base configuration example;

FIG. 2 is a diagram illustrating modes of an image forming apparatus;

FIG. 3 is a graph of the relationship between actual ratio and simplified ratio;

FIG. 4 is a graph of a cumulative exponential distribution;

FIG. 5 is a graph of the relationship between shift time and ratio;

FIG. 6 is a diagram illustrating results of a first concrete example;

FIG. 7 is a diagram illustrating results of a second concrete example;

FIG. 8 is a diagram illustrating results of a third concrete example;

FIG. 9 is a block diagram illustrating the hardware configuration of an image forming apparatus according to an exemplary embodiment;

FIG. 10 is a diagram illustrating an exemplary control procedure at the time of occurrence of a process in a first control example;

FIG. 11 is a diagram illustrating an exemplary procedure of a control system for a human detecting sensor in a second control example;

FIG. 12 is a diagram illustrating an exemplary control procedure at the time of occurrence of a process in the second control example;

FIG. 13 is a diagram illustrating another exemplary control procedure at the time of occurrence of a process in the second control example;

FIG. 14 is a diagram for describing a problem of a method in which, at the time of a return to the ready mode in response to a human detecting sensor's detection of a person, the mode just before the return is recorded and used in calculation of a shift time;

FIG. 15 is a diagram illustrating an exemplary procedure of control related to an outside detection area of a human detecting sensor in a third control example;

FIG. 16 is a diagram illustrating an exemplary procedure of control related to a human detecting sensor's detection area close to the apparatus, in the third control example; and

FIG. 17 is a diagram illustrating an exemplary control procedure at the time of a return to the ready mode in the third control example.

### DETAILED DESCRIPTION

### Exemplary Configuration of Base Apparatus

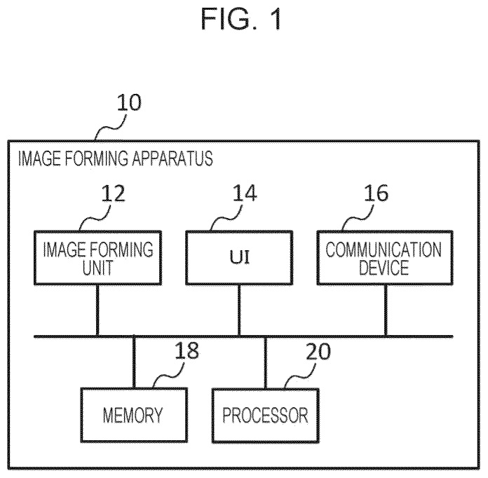

An exemplary configuration (hereinafter referred to as a “base configuration example”) of an image forming apparatus 10, serving as a base of an exemplary embodiment, will be described by referring to FIG. 1. Feature configuration and processes specific to the exemplary embodiment will be described after description about the base configuration example. FIG. 1 is a block diagram illustrating the hardware configuration of the image forming apparatus 10 according to the base configuration example.

The image forming apparatus 10 includes an image forming unit 12, a user interface (UI) 14, a communication device 16, a memory 18, and a processor 20. The image forming apparatus 10 is a printer, a scanner, a copier, a facsimile, or a multifunction device (for example, a device having functions of multiple devices, such as a printer, a scanner, and a copier). The image forming apparatus 10 is an exemplary information processing system.

The image forming unit 12 has at least one function among a print function, a scan function, a copy function, and a facsimile function. The system of printing, the system of scanning, and the like of the image forming unit 12 are not particularly limited. For example, an electrophotographic system, an inkjet system, a thermography system, or a thermal transfer system is used as the system of printing.

The UI 14, which is a user interface, includes a display and an input device. The display is, for example, a liquid-crystal display or an electroluminescence (EL) display. The input device is, for example, a keyboard, a mouse, and input keys, or an operation panel. The UI 14 may be a UI such as a touch panel (for example, an operation panel) serving as a display and an input device.

The communication device 16 includes one or more communication interfaces each having a communication chip, a communication circuit, or the like. The communication device 16 has a function of transmitting information to other apparatuses and a function of receiving information from other apparatuses. The communication device 16 may have a wireless communication function, such as Near Field Communication or Wi-Fi™, or may have a wired communication function.

The memory 18 is a device including one or more storage areas in which data is stored. The memory 18 is, for example, a hard disk drive (HDD), a solid-state drive (SSD), various types of memory (for example, a random-access memory (RAM), a dynamic random access memory (DRAM), a nonvolatile random access memory (NVRAM), and a read-only memory (ROM)), other types of storage device (for example, an optical disc), or a combination of these.

The processor 20 controls operations of the units of the image forming apparatus 10.

The image forming apparatus 10 has multiple modes having different times elapsing until execution of a process is ready. The time until execution of a process is ready may be a time for which a user waits for execution of the process. Thus, the time may be a waiting time of the user.

For example, the modes include ready mode and power saving mode. The power saving mode is a mode in which the time (that is, the waiting time) until execution of a process is ready is longer than that in the ready mode. The power saving mode may include multiple modes having different times elapsing until execution of a process is ready.

The ready mode is a mode in which the image forming apparatus 10 waits for execution of a process. The ready mode is a mode, in which power is supplied to the image forming apparatus 10 having warmed up and the image forming apparatus 10 is ready to perform a process, but is a mode in which the image forming apparatus 10 is not performing a process. Examples of a process include a print job, a scan job, a copy job, a job of transferring, to an external apparatus, image data generated through scanning, and a job of storing, in the image forming apparatus 10, image data generated through scanning. As a matter of course, these processes are merely examples. A process other than these processes may be performed by the image forming apparatus 10. A process performed by a user who operates the UI 14 may be a process according to the present base configuration example.

The power saving mode is a mode in which some components of the image forming apparatus 10 are not supplied with power, or a mode in which some or all components in the image forming apparatus 10 are supplied with power lower than that in the ready mode. The power consumed in the power saving mode is lower than that in the ready mode.

In the description below, the time until the mode of the image forming apparatus 10 is shifted from the ready mode to the power saving mode is referred to as a “shift time”. The set value of the shift time is stored in the memory 18. The processor 20 shifts the mode of the image forming apparatus 10 from the ready mode to the power saving mode in accordance with the shift time.

For example, assume the case in which the image forming apparatus 10 is in the ready mode. In this case, when the shift time elapses from when the image forming apparatus 10 has performed a process last (for example, when the process has been completed), or from when the image forming apparatus 10 has been operated by a user last, the processor 20 shifts the mode of the image forming apparatus 10 from the ready mode to the power saving mode. That is, when the time for which the image forming apparatus 10 does not perform a process such as a job or the time for which the UI 14 is not operated by a user is longer than or equal to the shift time, the processor 20 shifts the mode of the image forming apparatus 10 from the ready mode to the power saving mode.

In the case where the image forming apparatus 10 is in the ready mode, when a user gives an instruction for a shift to the power saving mode (for example, when a power-saving button disposed on the image forming apparatus 10 is pressed), the processor 20 may shift the mode of the image forming apparatus 10 from the ready mode to the power saving mode.

In the case where the image forming apparatus 10 is in the power saving mode, when a specific event occurs, the processor 20 shifts the mode of the image forming apparatus 10 from the power saving mode to the ready mode. Thus, the mode of the image forming apparatus 10 is returned to the ready mode.

The specific event is an event corresponding to an instruction to return to the ready mode. Examples of a specific event include an operation on the UI 14, reception of a job, reception of an instruction to perform a job, and pressing of a wake-up button. These are merely exemplary specific events. An event other than these may be defined as a specific event.

For example, when the UI 14 is operated by a user, the processor 20 shifts the mode of the image forming apparatus 10 from the power saving mode to the ready mode.

When the image forming apparatus 10 receives an instruction to perform a process, the processor 20 may shift the mode of the image forming apparatus 10 from the power saving mode to the ready mode. For example, when a print job is transmitted from an external apparatus to the image forming apparatus 10 and the processor 20 receives the print job, the processor 20 determines that a specific event has occurred, and shifts the mode of the image forming apparatus 10 from the power saving mode to the ready mode. The processor 20 controls the image forming unit 12 in accordance with the received print job to perform the print job.

When a wake-up button, which is disposed on an operation panel or the like of the image forming apparatus 10, is pressed, the processor 20 may shift the mode of the image forming apparatus 10 from the power saving mode to the ready mode.

When the power saving mode includes multiple different modes, a shift time is set to each mode, and the set value of each shift time is stored in the memory 18.

For example, the power saving mode includes Low Power mode (hereinafter referred to as “LP mode”) and Sleep mode (hereinafter referred to as “SP mode”).

The LP mode is a mode in which the time (that is, the waiting time) until execution of a process is ready is longer than that in the ready mode. The SP mode is a mode in which the time (that is, the waiting time) until execution of a process is ready is longer than that in the LP mode. The power consumed in the SP mode is lower than that in the LP mode. That is, the SP mode is a mode achieving a power-saving effect higher than that in the LP mode. In one example, the ready mode and the LP mode correspond to a first mode, and the SP mode corresponds to a second mode. In another example, the LP mode corresponds to the first mode, and the SP mode corresponds to the second mode. Further, for example, between the two modes of the ready mode and the SP mode, the ready mode corresponds to the first mode, and the SP mode corresponds to the second mode. Further, between the ready mode and the LP mode, the ready mode corresponds to the first mode, and the LP mode corresponds to the second mode.

In the ready mode, the units of the image forming apparatus 10 are supplied with power. For example, the image forming unit 12, the UI 14, the communication device 16, the memory 18, and the processor 20 are supplied with power. The image forming apparatus 10 is ready to perform a process such as a print job.

In the LP mode, the units of the image forming apparatus 10 are supplied with power lower than that in the ready mode. For example, in the LP mode, the scanner included in the image forming unit 12 and the operation panel included in the UI 14 are not supplied with power, or are supplied with power lower than that in the ready mode. For example, when the operation panel includes a backlight, the backlight is switched off. In the LP mode, the memory 18 and the processor 20 are supplied with power.

In the SP mode, the units of the image forming apparatus 10 are supplied with power lower than that in the LP mode. For example, in the SP mode, the image forming unit 12 and the UI 14 are not supplied with power, or are supplied with power lower than that in the LP mode. The power supplied to the memory 18 and the processor 20 may be lower than that in the LP mode.

The forms of power supply in the ready mode, the LP mode, and the SP mode, which are described above, are merely exemplary. Alternatively, forms of power supply other than those described above may be performed. The forms of power supply in the modes may be set by a user.

For example, the processor 20 changes the mode of the image forming apparatus 10 in the order of the ready mode, the LP mode, and the SP mode.

The set value of a first shift time (hereinafter referred to as an “LP shift time”) until the mode of the image forming apparatus 10 is shifted from the ready mode to the LP mode is stored in the memory 18, and the LP shift time is set to the image forming apparatus 10. The LP shift time is a time from the time point of start of the ready mode to the time point of start of the LP mode.

The set value of a second shift time (hereinafter referred to as an “SP shift time”) until the mode of the image forming apparatus 10 is shifted from the ready mode to the SP mode is stored in the memory 18, and the SP shift time is set to the image forming apparatus 10. The SP shift time is a time from the time point of start of the ready mode to the time point of start of the SP mode. The SP shift time is set to the same time as the LP shift time or a time longer than the LP shift time. Thus, in many cases, the mode of the image forming apparatus 10 is shifted in the order of the ready mode, the LP mode, and the SP mode. When the SP shift time is the same as the LP shift time, the mode of the image forming apparatus 10 is shifted from the ready mode, not to the LP mode, but to the SP mode. The SP shift time may be a time from the time point of start of the LP mode to the time point of start of the SP mode.

In the case where the image forming apparatus 10 is in the ready mode, when the time for which the image forming apparatus 10 does not perform a job or the time for which the UI 14 is not operated by a user is longer than or equal to the LP shift time, the processor 20 shifts the mode of the image forming apparatus 10 from the ready mode to the LP mode. That is, when the LP shift time elapses from the time point when a process or an operation has been performed last, the processor 20 shifts the mode of the image forming apparatus 10 from the ready mode to the LP mode. In the case where the image forming apparatus 10 is in the LP mode, when a specific event which causes a return to the ready mode occurs, the processor 20 shifts the mode of the image forming apparatus 10 from the LP mode to the ready mode.

Even when the time for which the image forming apparatus 10 does not perform a process or the time for which the UI 14 is not operated by a user is shorter than the LP shift time, the processor 20 may shift the mode of the image forming apparatus 10 from the ready mode to the LP mode. For example, when the image forming apparatus 10 is in the LP mode and the processor 20 receives a print job from an external apparatus, the processor 20 shifts the mode of the image forming apparatus 10 from the LP mode to the ready mode to perform the print job. Without waiting until the LP shift time elapses after completion of the print job, the processor 20 may return the mode of the image forming apparatus 10 to the power saving mode (LP mode) which is the mode at the time point when the processor 20 has received the print job. That is, in the case where the image forming apparatus 10 is in the LP mode, when the processor 20 receives a print job, the mode of the image forming apparatus 10 is returned to the LP mode immediately after completion of the print job.

In the case where the image forming apparatus 10 is in the LP mode, when the time for which the image forming apparatus 10 does not perform a process or the time for which the UI 14 is not operated by a user is longer than or equal to the SP shift time, the processor 20 shifts the mode of the image forming apparatus 10 from the LP mode to the SP mode. That is, when the SP shift time elapses from the time point when a process or an operation has been performed last, the processor 20 shifts the mode of the image forming apparatus 10 from the LP mode to the SP mode. In the case where the image forming apparatus 10 is in the SP mode, when a specific event which causes a return to the ready mode occurs, the processor 20 shifts the mode of the image forming apparatus 10 from the SP mode to the ready mode.

Even when the time for which the image forming apparatus 10 does not perform a process or the time for which the UI 14 is not operated by a user is shorter than the SP shift time, the processor 20 may shift the mode of the image forming apparatus 10 from the ready mode to the SP mode. For example, in the case where the image forming apparatus 10 is in the SP mode, when the processor 20 receives a print job from an external apparatus, the processor 20 shifts the mode of the image forming apparatus 10 from the SP mode to the ready mode to perform the print job. Without waiting until the SP shift time elapses after completion of the print job, the processor 20 may return the mode of the image forming apparatus 10 to the power saving mode (SP mode) which is the mode at the time point when the processor 20 has received the print job. That is, in the case where the image forming apparatus 10 is in the SP mode, when the processor 20 receives a print job, the mode of the image forming apparatus 10 is returned to the SP mode immediately after completion of the print job.

The time (that is, the waiting time) required for a shift from the power saving mode to the ready mode is different depending on the type of the power saving mode. Power supplied in the SP mode is lower than that in the LP mode. Therefore, the time required for a shift from the SP mode to the ready mode is longer than that from the LP mode to the ready mode.

The LP mode and the SP mode are merely exemplary power saving modes. The image forming apparatus 10 may have three or more different power saving modes. As a matter of course, the power saving mode may be a single mode.

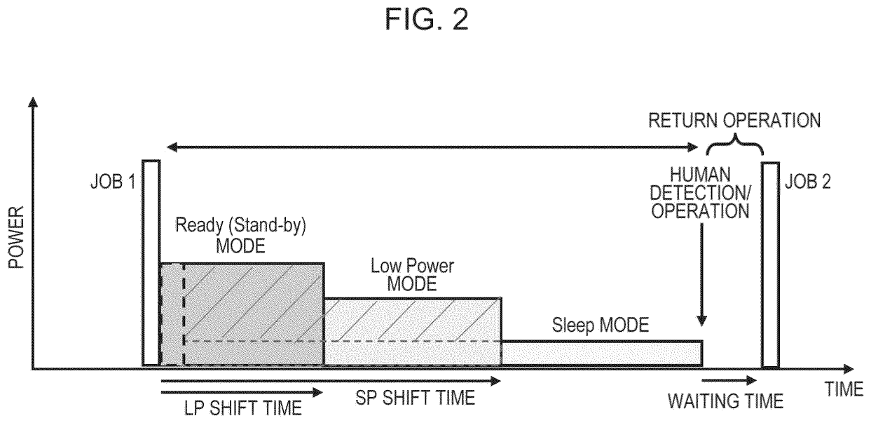

FIG. 2 illustrates power levels consumed in the ready mode, the LP mode, and the SP mode. In FIG. 2, the horizontal axis represents time; the vertical axis represents power consumption. In this example, jobs, which serve as processes, are performed.

For example, when the image forming apparatus 10 performs Job 1 (for example, a print job) and the execution of Job 1 completes, the mode of the image forming apparatus 10 is shifted to the ready mode. When the LP shift time elapses from the time point of completion of Job 1 without execution of any job or operation, the processor 20 shifts the mode of the image forming apparatus 10 from the ready mode to the LP mode. Further, when the SP shift time elapses from the time point of completion of Job 1 without execution of a job or operation, the processor 20 shifts the mode of the image forming apparatus 10 from the LP mode to the SP mode.

In the case where the image forming apparatus 10 is in the SP mode, when a specific event which causes a return to the ready mode occurs (for example, when the UI 14 is operated or the processor 20 receives a job), the processor 20 shifts the mode of the image forming apparatus 10 from the SP mode to the ready mode. When the processor 20 receives a job (for example, Job 2), the processor 20 performs Job 2 which has been received. The time from the time point of completion of the SP mode to the time point of start of execution of Job 2 corresponds to the waiting time of the SP mode.

In the case where the image forming apparatus 10 is in the LP mode, when a specific event which causes a return to the ready mode occurs, the processor 20 shifts the mode of the image forming apparatus 10 from the LP mode to the ready mode. The time from the time point of completion of the LP mode to the time point of start of execution of a job corresponds to the waiting time of the LP mode.

For example, the waiting time of the SP mode is three seconds; the waiting time of the LP mode is one second or less. In the case where the image forming apparatus 10 is in the ready mode, the time required until execution of a job (that is, the time corresponding to the waiting time of the ready mode) is one second or less. These times are merely exemplary, and may change, for example, depending on the type, function, or performance of the image forming apparatus 10.

Typically, as a shift time, such as the LP shift time or the SP shift time, is longer, the time until the mode of the image forming apparatus 10 is shifted to the LP mode or the SP mode is longer, resulting in improvement of user convenience. In contrast, this creates a larger standby power consumption, resulting in degradation of power saving. Conversely, a shorter shift time causes improvement of power saving but causes reduction of user convenience. A user may set a shift time in accordance with the utilization of the image forming apparatus 10 (for example, the frequency of execution of jobs). However, such setting by a user is difficult to achieve both improvement of convenience and improvement of power saving.

In the present base configuration example, the processor 20 manages a history (hereinafter, referred to as a “process history”) indicating the count of processes performed in each of at least two modes. Information indicating the process history is stored in the memory 18. On the basis of the process history and the target value of the ratio of specific processes performed by the image forming apparatus 10, the processor 20 outputs the set value of a shift time elapsing until the image forming apparatus 10 is shifted to a mode in which a time until execution of a process is ready is longer than that in another mode. For example, the set value is stored in the memory 18. In accordance with the set value, the processor 20 shifts the mode of the image forming apparatus 10 to the mode in which the time until execution of a process is ready is longer than that in another mode. The set value of a shift time may be a set value of the SP shift time, may be a set value of the LP shift time, or may be set values of both the SP shift time and the LP shift time. For example, the target value of the ratio of specific processes corresponds to convenience of users of the image forming apparatus 10. For example, the convenience is evaluated in view of whether the image forming apparatus 10 is allowed to be used with a shorter waiting time. The target value of the ratio of specific processes is a target value corresponding to the ratio of the count of processes which is described below.

The count of processes may be the count of processes performed through operations on the UI 14, may be the count of execution of print jobs requested remotely over a network or the like, or may be the total of the count of processes performed through operations on the UI 14 and the count of execution of print jobs and the like requested remotely.

For example, the process history includes the count of processes performed in a predetermined period.

In the description below, the count of processes performed in the ready mode is referred to as “R”; the count of processes performed in the LP mode is referred to as “LP”; the count of processes performed in the SP mode is referred to as “SP”.

For example, the process history may include the count of processes performed in all the modes. That is, the process history in this case includes the total of the count of processes performed in the ready mode, the count of processes performed in the LP mode, and the count of processes performed in the SP mode. Hereinafter, the total is referred to as the total process count: total process count=R+LP+SP.

The process history may include the total of the counts of processes performed in the power saving mode. That is, the process history in this case includes the total of the count of processes performed in the LP mode and the count of processes performed in the SP mode. Hereinafter, the total is referred to as the process count in the power saving mode: process count in power saving mode=LP+SP.

The predetermined period may be defined by a user. Examples of the predetermined period include a period in hours, a period in days, a period in weeks, a period in months, and any other periods.

If the count of operations on the UI 14 in the period is less than or equal to a predetermined count, the history may include the count of execution of jobs, such as a print job and a copy job, or the total of the counts.

For example, the processor 20 counts processes performed in at least two modes among the ready mode, the LP mode, and the SP mode, and stores, in the memory 18, information indicating the count of processes performed in each mode (that is, information indicating the process history).

The count of processes performed in the ready mode is the count of processes performed when the image forming apparatus 10 is in the ready mode.

The count of processes performed in the LP mode is the count of processes performed when the image forming apparatus 10 is in the LP mode. In other words, the count of processes performed in the LP mode is the count of occurrence of specific events when the image forming apparatus 10 is in the LP mode. For example, the count of processes performed in the LP mode includes the following counts in the image forming apparatus 10 which is in the LP mode: the count of shifts of the mode of the image forming apparatus 10 from the LP mode to the ready mode due to operations on the UI 14; the count of shifts of the mode of the image forming apparatus 10 from the LP mode to the ready mode due to jobs received by the processor 20.

The count of processes performed in the SP mode is the count of processes performed when the image forming apparatus 10 is in the SP mode. In other words, the count of processes performed in the SP mode is the count of occurrence of specific events when the image forming apparatus 10 is in the SP mode. For example, the count of processes performed in the SP mode includes the following counts in the image forming apparatus 10 which is in the SP mode: the count of shifts of the mode of the image forming apparatus 10 from the SP mode to the ready mode due to operations on the UI 14; the count of shifts of the mode of the image forming apparatus 10 from the SP mode to the ready mode due to jobs received by the processor 20.

The target value may be predetermined, may be determined by a user, or may be calculated through learning for calculating the target value.

The set value which is output may be a set value of the LP shift time, may be a set value of the SP shift time, or may be values of both the LP shift time and the SP shift time.

When the set value which is output is a set value of the LP shift time, the processor 20 shifts the mode of the image forming apparatus 10 from the ready mode to the LP mode in accordance with the set value which is output. When the set value which is output is a set value of the SP shift time, the processor 20 shifts the mode of the image forming apparatus 10 from the LP mode to the SP mode in accordance with the set value which is output.

When only either one of the LP mode and the SP mode is set as the power saving mode, the set value which is output is a set value of the shift time in the mode which is set as the power saving mode. In this case, the processor 20 shifts the mode of the image forming apparatus 10 from the ready mode to the set mode in accordance with the set value.

For example, the process history includes the ratio related to the counts of processes performed in the respective at least two modes. Exemplary ratios are the following:

$$ratio 1 \text{:} ( R + LP ) / ( R + LP + SP ) ,$$

$$ratio 2 \text{:} LP / ( LP + SP ) ,$$

where, as described above, R, LP, and SP represent the count of processes performed in the ready mode, the count of processes performed in the LP mode, and the count of processes performed in the SP mode, respectively.

Ratios 1 and 2 described above correspond to values indicating convenience of users of the image forming apparatus 10. Specifically, each of ratios 1 and 2 is the ratio of the count of processes for which the waiting time is less than or equal to a threshold. For example, the threshold is one second. The threshold is merely exemplary, and is determined, for example, depending on the type, function, or performance of the image forming apparatus 10. For example, since each of the waiting time of the ready mode and the waiting time of the LP mode is one second or less, the threshold is set to one second. If these waiting times change, the threshold is set in accordance with the change. When the threshold is set to one second, each of ratios 1 and 2 corresponds to the ratio of processes performed after a waiting time which is one second or less. The higher ratio 1 is, the larger the count of processes performed after a waiting time which is one second or less is. This may indicate higher user convenience in view of earlier execution of jobs. The same is true for ratio 2. Therefore, ratios 1 and 2 represent user convenience.

Ratio 1 is the ratio of the count of processes, for which the waiting time is less than or equal to the threshold, with respect to the count of processes performed in all the modes. The count of processes performed in all the modes is the total of the count of processes performed in the ready mode, the count of processes performed in the LP mode, and the count of processes performed in the SP mode.

The count of processes, for which the waiting time is less than or equal to the threshold, is the total of the count of processes performed in the ready mode and the count of processes performed in the LP mode.

Ratio 2 is a ratio calculated without using the count of processes performed in the ready mode, and is a ratio obtained by simplifying ratio 1. Ratio 2 may be a simplified ratio. The processes performed in the LP mode are counted by counting returns of the mode of the image forming apparatus 10 from the LP mode to the ready mode. Processes performed in the SP mode are counted by counting returns of the mode of the image forming apparatus 10 from the SP mode to the ready mode. In contrast, for the ready mode, processes performed in the ready mode are counted by counting, not returns, but processes actually performed in the ready mode. For example, when processes (for example, print jobs) are performed continuously in the ready mode, a shift between modes does not occur. Thus, it may be difficult to accurately count jobs performed continuously. That is, it may not be obvious whether the count of processes which are continuously performed is one, or more than one. Use of ratio 2 eliminates necessity of counting processes performed in the ready mode.

A user may select, from ratios 1 and 2, a ratio to be used, or a ratio to be used may be predetermined.

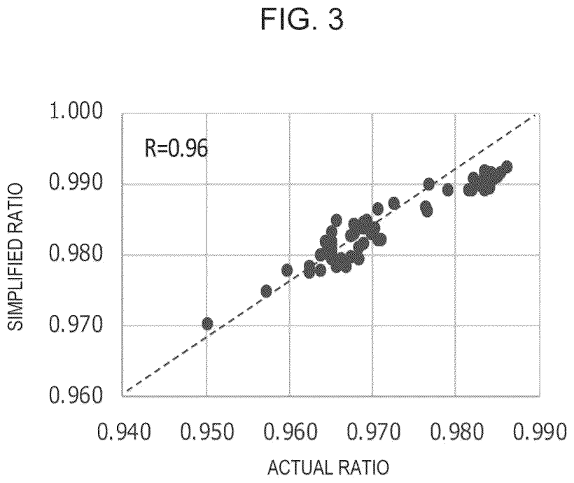

Referring to FIG. 3, the relationship between ratio 1 and ratio 2 will be described. FIG. 3 illustrates a graph of the relationship between ratio 1 and ratio 2. The horizontal axis represents ratio 1 which is an actual ratio. The vertical axis represents ratio 2 which is a simplified ratio. As illustrated in FIG. 3, there is a correlation between ratio 1 and ratio 2. Thus, instead of calculation of ratio 1, calculation of ratio 2 enables the ratio of the count of processes, for which the waiting time is less than or equal to the threshold, to be calculated.

For example, the processor 20 calculates the set value of a shift time from the process history and the target value by using a cumulative exponential distribution function.

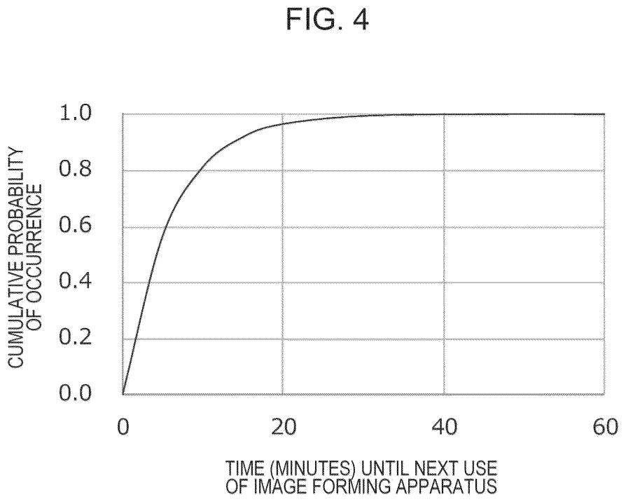

Referring to FIG. 4, the cumulative exponential distribution function will be described. FIG. 4 illustrates an exemplary cumulative exponential distribution function. The horizontal axis represents time (minutes) elapsing until next use of the image forming apparatus 10; the vertical axis represents cumulative probability f(t) of occurrence.

The cumulative probability f(t) of occurrence is a probability that events occur, in a unit time, λ times in average, and is expressed in Expression (1):

$$f ( t ) = 1 - e \hat{} ( - λ t ) , \qquad ( 1 )$$

where t represents time.

The time until next use of the image forming apparatus 10 corresponds to a shift time (for example, the SP shift time). The cumulative probability of occurrence corresponds to the probability that the image forming apparatus 10 is allowed to be used without a shift of the image forming apparatus 10 to the SP mode. Specifically, the cumulative probability of occurrence corresponds to a ratio described above (for example, ratio 1 or ratio 2).

The distribution obtained when the image forming apparatus 10 is actually used (for example, the relationship between the SP shift time and ratio) does not match an ideal cumulative exponential distribution. However, the actual distribution is close to the ideal cumulative exponential distribution. In the present base configuration example, for example, the processor 20 estimates the cumulative exponential distribution function by learning such as machine learning, and calculates the set value of the shift time by using the estimated cumulative exponential distribution function.

The processor 20 estimates a cumulative exponential function on the basis of the process history in a learning period, and calculates the set value of a shift time. The learning period is a predetermined period, and is, for example, a period in units of hours (for example, one hour or two hours), a period in units of days (for example, one day or two days), a period in units of weeks (for example, one week or two weeks), or a period in units of months (for example, one month or two months). In accordance with the calculated shift time, the processor 20 controls shifting the mode of the image forming apparatus 10. After the learning period, the processor 20 learns a cumulative exponential function for each unit control period to update the set value of the shift time. The unit control period is a predetermined period, and is, for example, a period in units of hours (for example, one hour or two hours), a period in units of days (for example, one day or two days), a period in units of weeks (for example, one week or two weeks), or a period in units of months (for example, one month or two months).

The processor 20 counts processes performed in each of the ready mode, the LP mode, and the SP mode in the learning period. For example, for the LP mode and the SP mode, the processor 20 counts shifts from the LP mode to the ready mode (that is, returns from the LP mode) in the learning period, and counts shifts from the SP mode to the ready mode (that is, returns from the SP mode) in the learning period. The count of processes is not limited to the count of execution of jobs, and the count of operations on the UI 14 may be included in the count of processes. That is, the count of mode shifts to the ready mode due to operations on the UI 14 may be included in the count of processes.

For example, on the basis of the counts of processes performed in the learning period, the processor 20 calculates ratio 1 (=(R+LP)/(R+LP+SP)). The processor 20 may calculate ratio 2 (=LP/(LP+SP)) which is a simplified ratio. In the case of use of ratio 2, processes performed in the ready mode are not necessarily counted. In this example, ratio 1 is used.

To avoid impossibility of calculating a cumulative index, extreme values may be used. For example, when ratio 1 exceeds 0.99 (that is, when ratio 1 exceeds 99%), the processor 20 may use 0.99 (that is, 99%) as ratio 1. When ratio 1 is less than 0.01 (that is, when ratio 1 is less than 1%), the processor 20 may use 0.01 (that is, 1%) as ratio 1.

The processor 20 sets the target value. For example, as given by Expression (2), the processor 20 sets, to the target value, a value obtained by subtracting a predetermined value from ratio 1 obtained in the learning period. For example, the predetermined value, which may be set by a user, is 0.1 (that is, 10%):

$$target value = ratio 1 in learning period - 0.1 . \qquad ( 2 )$$

As described above, ratio 1 represents user convenience. Thus, subtraction of the predetermined value (for example, 0.1) from the ratio in the learning period means that the convenience is reduced by that value.

When the target value is less than 0.01 (that is, in the case of less than 1%), the processor 20 sets 0.01 (that is, 1%) to the target value.

For example, when ratio 1 is 13%, the target value is 3%. When ratio 1 is 12%, the target value is 2%. When ratio 1 is 11%, the target value is 1%. When ratio 1 is 10%, the target value is 1%. When ratio 1 is 9%, the target value is 1%.

Through use of a cumulative exponential distribution function, a ratio (for example, ratio 1 or ratio 2) is given by Expression (3):

$$ratio = 1 - e \hat{} ( - λ \times set value of SP shift time ) . \qquad ( 3 )$$

λ represents the average count of occurrence of events in a unit time, and is calculated by dividing the count (the total process count=R+LP+SP) of processes, which are performed in the latest period (for example, the latest week), by its corresponding use time (for example, a value obtained by converting the use time in the latest week to hour units).

The use time may be calculated by predetermining a use time (for example, eight hours per day) per average day and multiplying the predetermined use time by the number of days of use, or may be calculated, for example, from the power supply time of the image forming apparatus 10.

Expression (4) described below is obtained from transformation of Expression (3). Thus, the set value of the SP shift time in the latest period (for example, the latest week) and the ratio in that period (for example, ratio 1) are substituted into Expression (4) to calculate 2:

$$λ = {log}_{e} ( 1 - ratio ) / ( set value of SP shift time ) . \qquad ( 4 )$$

The process count (LP+SP) in the power saving mode may be used as the count of processes performed in the latest period (for example, the latest week).

Expression (5) is obtained through transformation of Expression (3):

$$set value of SP shift time = - {log}_{e} ( 1 - ratio ) / λ . \qquad ( 5 )$$

On the basis of Expression (5), the processor 20 calculates the set value of the SP shift time for setting ratio 1 in the next week to the target value (that is, ratio 1 in the learning period −0.1). Expression (6) described below is an expression to calculate the set value:

$$set value of SP shift time in next week = - {log}_{e} ( 1 - target value ) / λ . \qquad ( 6 )$$

The processor 20 rounds off, to the nearest integer, the set value of the SP shift time in the next week.

The processor 20 may compensate the set value of the SP shift time in the next week, which is obtained by using Expression (6).

When the initial value of the SP shift time<the set value of the SP shift time in the next week, the processor 20 replaces the set value of the SP shift time in the next week by the initial value, and continues automatic control. In the case of the initial value of 60, when this condition is satisfied, the set value of the SP shift time in the next week is set to 60.

When the set value of the SP shift time in the next week is below the lower limit settable for the SP shift time, the processor 20 replaces the set value of the SP shift time in the next week by the lower limit, and continues the automatic control. For example, the lower limit settable for the SP shift time is one. When the set value of the SP shift time in the next week is zero, that is, when the set value before the round-off is less than, for example, 0.5, this condition is satisfied. In this case, the set value of the SP shift time in the next week is set to one.

When 1≤the set value of the SP shift time in the next week≤the initial value, the processor 20 controls the image forming apparatus 10 in accordance with the calculated set value of the SP shift time in the next week.

When the count (for example, the total of the count of processes performed in the ready mode, the count of processes performed in the LP mode, and the count of processes performed in the SP mode) of processes in a first unit control period (for example, this week) is less than a threshold, the processor 20 may determine that the first unit control period is an invalid period. For example, the threshold is 25. The threshold may be set by a user. For example, in the case where the first unit control period is a single week, when the count in the single week is less than 25, the processor 20 determines that the period is an invalid period. For example, when it is determined that a unit control period is an invalid period, the processor 20 may use the set value in this week as the set value in the next week. For example, when the count of processes is less than the threshold, it is assumed that the way of using the image forming apparatus 10 is changed, for example, due to consecutive holidays or a long vacation.

Thus, when the count of processes in the first unit control period (for example, this week) is less than the threshold (for example, 25), the processor 20 outputs the set value of the shift time in the first unit control period as the set value of the shift time in the second unit control period (for example, the next week). That is, the processor 20 sets the set value of the shift time for this week to the set value of the shift time for the next week.

A concrete example of learning and control after the learning will be described below. A concrete example of learning will be described first and a concrete example of automatic control of modes using the learning result will be then described. Values described below are merely exemplary. The values may be changed, for example, in accordance with the operating environment of the image forming apparatus 10, user circumstances, and the functions of the image forming apparatus 10.

### Learning Step

### Step S01: At a Start

The processor 20 counts processes performed in each of the ready mode, the LP mode, and the SP mode during a learning period (that is, the counts of returns to the ready mode). The count of processes includes, not only the count of execution of jobs, but also the count of operations on the UI 14. For example, as a rule, a learning period is one week. Exceptionally, a learning period is extended on a week-by-week basis.

An initial set value is used as the SP shift time in the learning period. An initial set value may be used as the LP shift time in the learning period. Alternatively, when influence of the LP shift time on convenience is small, the shortest time which is settable may be used as the LP shift time in the learning period. For example, the time required until execution of a job in the ready mode (that is, the time corresponding to the waiting time of the ready mode) is less than or equal to one second. The waiting time of the SP mode is three seconds. The waiting time of the LP mode is less than or equal to one second. That is, the waiting time of the LP mode is less than or equal to one second, which is equivalent to that in the ready mode. Thus, in this example, the shortest time, one, is used as the LP shift time in learning.

### Step S02: After One Week

According to the determination criteria described below, the processor 20 determines whether the process count in the first learning period (that is, the first week) is valid:

{count of processes performed in ready mode+count of processes performed in LP mode (that is, count of returns from LP mode)+count of processes performed in SP mode (that is, count of returns from SP mode)}≥25: valid,

{count of processes performed in ready mode+count of processes performed in LP mode (that is, count of returns from LP mode)+count of processes performed in SP mode (that is, count of returns from SP mode)}<25: invalid.

If the process count is valid, the processor 20 stores, as a first-week actual value, the count of processes preformed in the ready mode, the count of returns from the LP mode, and the count of returns from the SP mode in the memory 18.

If the count is invalid, the processor 20 discards the counts obtained in the learning period, and extends the learning period to the next week. If the process count is less than the threshold (for example, 25), it is assumed that the way of using the image forming apparatus 10 has been changed, for example, due to consecutive holidays or a long vacation. In this case, to avoid reflection of the influence on the next week, the counts are discarded and the learning period is extended to the next week.

### Step S03: After Two Weeks

According to the same determination criteria as those in step S02, the processor 20 determines whether the process count obtained in the next learning period (that is, the second week) is valid.

If the process count is valid, when the first-week actual value is stored in the memory 18, the processor 20 stores a second-week actual value (that is, the count of processes preformed in the ready mode, the count of returns from the LP mode, and the count of returns from the SP mode, which are obtained in the second week) in the memory 18. The processor 20 ends the learning, and sets the target value. The process proceeds, not to step S04, but to step S05.

If the process count is valid, when the first-week actual value is not stored in the memory 18, the second-week actual value is stored in the memory 18 as the first-week actual value. The processor 20 extends the learning period to the next week, and continues the learning. The process proceeds to step S04.

If the process count is invalid, the processor 20 discards the counts obtained in the second week, extends the learning period to the next week, and continues the learning. The process proceeds to step S04.

### Step S04: After Another Week

According to the same determination criteria as those in step S02, the processor 20 determines whether the process count obtained in another next learning period (that is, the third week) is valid.

If the process count is valid, when the first-week actual value is stored in the memory 18, the processor 20 stores, as the second-week actual value, a third-week actual value (that is, the count of processes performed in the ready mode, the count of returns from the LP mode, and the count of returns from the SP mode, which are obtained in the third week) in the memory 18. The processor 20 ends the learning, and sets the target value. The process proceeds to step S05.

If the process count is valid, when a first-week actual value is not stored in the memory 18, the third-week actual value is stored as the first-week actual value in the memory 18. The processor 20 extends the learning period to the next week, and continues the learning. For example, the processor 20 performs the same process in step S04 on the basis of the counts obtained in the next week.

If the process count is invalid, the processor 20 discards the counts obtained in the week, extends the learning period to the next week, and continues the learning.

The processor 20 may repeatedly perform the process in step S04.

### Step S05: Setting the Target Value

The processor 20 calculates ratio 1, (R+LP)/(R+LP+SP). The counts of processes performed in the ready mode, which are included in the first-week actual value and the second-week actual value, are used as R. The counts of returns from the LP mode, which are included in the first-week actual value and the second-week actual value, are used as LP. The counts of returns from the SP mode, which are included in the first-week actual value and the second-week actual value, are used as SP. The count of processes performed in the ready mode, which is included in the first-week actual value or the second-week actual value, may be used as R. The count of returns from the LP mode, which is included in the first-week actual value or the second-week actual value, may be used as LP. The count of returns from the SP mode, which is included in the first-week actual value or the second-week actual value, may be used as SP.

For example, if ratio 1 exceeds 0.99 (that is, 99%), the processor 20 may use 0.99 as ratio 1. If ratio 1 is less than 0.01 (that is, 1%), the processor 20 may use 0.01 as ratio 1.

Then, the processor 20 calculates the target value according to Expression (2) described above. In this case, when the calculated target value is less than the lower limit (for example, 0.01), the processor 20 sets the lower limit to the target value.

### Automatic Control Step

### Step S11: At a Start

After the target value is calculated in the learning step, the processor 20 then calculates the set value of a shift time. In this example, the processor 20 calculates the set value of the SP shift time. As a matter of course, the processor 20 may calculate the set values of both the LP shift time and the SP shift time, or may calculate only the set value of the LP shift time.

### (1) Calculate 2 of the Cumulative Exponential Distribution Function

According to Expression (7) described below, the processor 20 calculates 2 of the cumulative exponential distribution function:

$$λ = total process count ( R + LP + SP ) in learning period ( two weeks ) / use time in learning period . \qquad ( 7 )$$

The use time in the learning period may be calculated by predetermining, for example, an average use time (for example, eight hours per day) and multiplying the average use time by the number of days of use, or may be calculated, for example, from the power supply time of the image forming apparatus 10. In this example, the set value of the SP shift time in the learning period is the initial set value of the SP shift time.

### (2) Calculate the Set Value of the SP Shift Time

Then, the processor 20 substitutes 2, which is calculated by using Expression (7) described above, and the target value into Expression (8) described below to calculate the set value of the SP shift time:

$$set value of SP shift time = - {log}_{e} ( 1 - target value ) / λ . \qquad ( 8 )$$

The target value in this example is a value calculated by using Expression (2) described above. The processor 20 rounds off the set value of the SP shift time to the nearest integer.

### (3) Compensate the Set Value

The processor 20 may compensate the set value of the SP shift time. For example, when the set value of the SP shift time is greater than the initial value, the processor 20 sets the initial value to the set value of the SP shift time. When the set value of the SP shift time is zero, the processor 20 sets one to the set value of the SP shift time.

In accordance with the set value described above, the processor 20 controls shifting the mode of the image forming apparatus 10. The processor 20 counts processes, which are performed in the ready mode, and processes (that is, returns from each of the LP mode and the SP mode), which are performed in each of the LP mode and the SP mode, during a unit control period (in this example, one week). The count of processes includes, not only the count of execution of jobs, but also the count of operations on the UI 14.

### Step S12: After One Week

### (1) Determine Whether Data is Valid

The processor 20 determines whether the process count obtained in the latest week is valid according to the determination criteria described below:

{count of processes performed in ready mode in latest week+count of processes performed in LP mode in latest week (that is, count of returns from LP mode)+count of processes performed in SP mode in latest week (that is, count of returns from SP mode)}≥25: valid,

{count of processes performed in ready mode in latest week+count of processes performed in LP mode in latest week (that is, count of returns from LP mode)+count of processes performed in SP mode in latest week (that is, count of returns from SP mode)}<25: invalid.

If the process count is valid, the processor 20 performs processes in step S12 (2) and its subsequent steps which are described below.

If the process count is invalid, the processor 20 discards the counts obtained in the latest week, and does not perform processes in step S12 (2) and its subsequent steps. In this case, the processor 20 sets the set value of the SP shift time, which was used in this week, to the set value for the next week, and continues the control.

### (2) Calculate 2 of the Cumulative Exponential Distribution Function

If it is determined that the data is valid in step S12 (1) described above, the processor 20 performs processes in step S12 (2) and its subsequent steps. According to Expression (9) described below, the processor 20 calculates λ of the cumulative exponential distribution function:

$$λ = total process count ( R + LP + SP ) in latest week / use time in learning period . \qquad ( 9 )$$

The use time in the latest week may be calculated by predetermining, for example, an average use time (for example, eight hours per day) and multiplying the average use time by the number of days of use, or may be calculated, for example, from the power supply time of the image forming apparatus 10.

### (3) Calculate the Set Value of the SP Shift Time

Then, the processor 20 substitutes λ, which is calculated by using Expression (9) described above, and the actual value of ratio 1 in the latest week into Expression (10) described below to calculate the set value of the SP shift time for the next week:

$$set value of SP shift time for next week = - {log}_{e} ( 1 - ratio in latest week ) / λ . \qquad ( 10 )$$

The processor 20 rounds off the set value of the SP shift time to the nearest integer.

### (4) a Branching Process Using the Set Value of the SP Shift Time

The processor 20 performs the process, described below, in accordance with the set value of the SP shift time for the next week which is calculated in step S12 (3):
(a) the initial value<the set value of the SP shift time: the processor 20 replaces the set value of the SP shift time for the next week by the initial value, and continues the automatic control,
(b) 1≤the set value of the SP shift time<the initial value: the processor 20 adopts the calculated set value of the SP shift time for the next week, and continues the automatic control in accordance with the set value,
(c) the set value of the SP shift time=0: the processor 20 replaces the set value of the SP shift time for the next week by one, and continues the automatic control.

If (a), (b), or (c) described above is satisfied, in the next week, the processor 20 controls shifting the mode of the image forming apparatus 10 in accordance with the calculated set value of the SP shift time for the next week.

### Step S13: After Another Week

After that, the processor 20 performs the process in step S12 at the end of every week. Thus, the processor 20 repeatedly performs the process in step S12 at the end of every week.

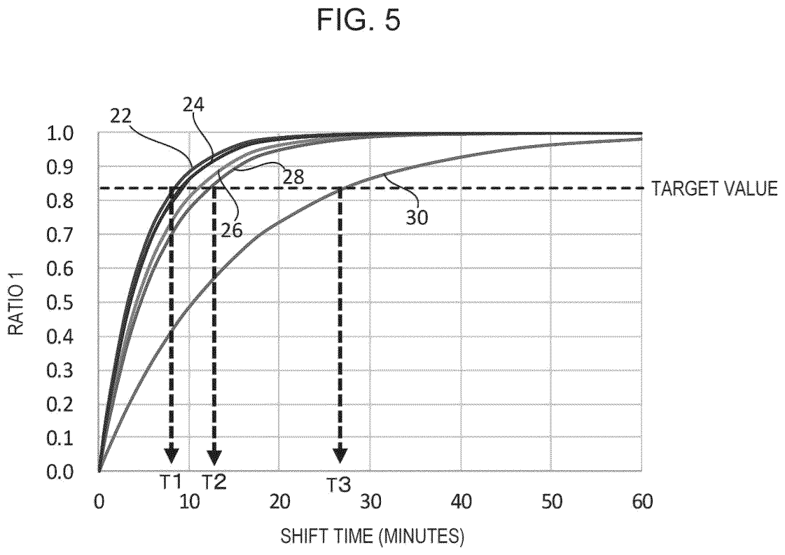

Referring to FIG. 5, the relationship between ratio 1 and the SP shift time will be described. FIG. 5 illustrates a graph showing the relationship. The horizontal axis represents the SP shift time; the vertical axis represents the actual value of ratio 1. The functions indicated by even-numbered curves 22 to 30 are calculated, for example, by using Expression (9) and Expression (10) described above.

The even-numbered curves 22 to 30 show the relationships between ratio 1 and the SP shift time in different weeks. The value of 2 changes depending on the way of using the image forming apparatus 10 or its operating environment. As a result, the curves have different shapes, resulting in change of the shift time corresponding to the target value.

For example, when Curve 22 is obtained from use of the image forming apparatus 10 in a certain week, the shift time corresponding to the target value of ratio 1 is Shift time T1. In this case, the processor 20 sets T1 to the set value of the SP shift time, and controls shifting the mode of the image forming apparatus 10. Similarly, when Curve 28 is obtained, Shift time T2 is used as a set value. When Curve 30 is obtained, Shift time T3 is used as a set value. Thus, the set value of a shift time is changed in accordance with the way of using the image forming apparatus 10.

For example, the curve may change in accordance with the way of using the image forming apparatus 10, and the set value of a shift time may change. Specifically, the way of using the image forming apparatus 10 may change, for example, due to a busy period, consecutive holidays, or a long vacation, resulting in acquisition of a changed curve. Alternatively, the curve may change in accordance with the operating environment of the image forming apparatus 10, and the set value of a shift time may change. Specifically, a changed curve may be obtained, for example, due to business hours, business form, or the number of persons using the image forming apparatus 10. Even when the way of use or the operating environment changes, the set value of a shift time is calculated through learning, and shifting the mode of the image forming apparatus 10 is controlled in accordance with the set value.

The processor 20 may estimate the change of the environment of the image forming apparatus 10 on the basis of the change of the set value of a shift time. For example, when the difference between the set value in the latest unit control period and the set value in its immediately preceding unit control period is greater than or equal to a threshold, the processor 20 determines that the operating environment of the image forming apparatus 10 has changed. The threshold is predetermined. The threshold may be set by a user. When the difference is less than the threshold, the processor 20 determines that the operating environment of the image forming apparatus 10 has not changed.

For example, when the processor 20 determines that the operating environment of the image forming apparatus 10 has changed, the processor 20 resets the learning and performs the learning again. When the processor 20 determines that the operating environment of the image forming apparatus 10 has not changed, the processor 20 continues the automatic control.

For example, when the operating environment of the image forming apparatus 10 has changed, like Curve 30, the shape of an obtained curve is different by a large degree from the shapes of the other curves (for example, the even-numbered curves 22 to 28). Therefore, even when the target value is the same, the set value of a shift time, which is obtained from Curve 30, is different by a large degree from the set values of a shift time, which are obtained from the curves other than Curve 30 (for example, the even-numbered curves 22 to 28). That is, the difference between the set value of a shift time, which is obtained from Curve 30, and the set value of a shift time, which is obtained from a curve other than Curve 30, is greater than or equal to the threshold. Thus, through calculation of the difference between set values of a shift time, it may be determined whether the operating environment of the image forming apparatus 10 has changed.

The processor 20 may output information indicating that the operating environment of the image forming apparatus 10 has changed or information indicating that the operating environment of the image forming apparatus 10 has not changed. For example, the processor 20 may display the information on the display of the UI 14.

### Concrete Examples

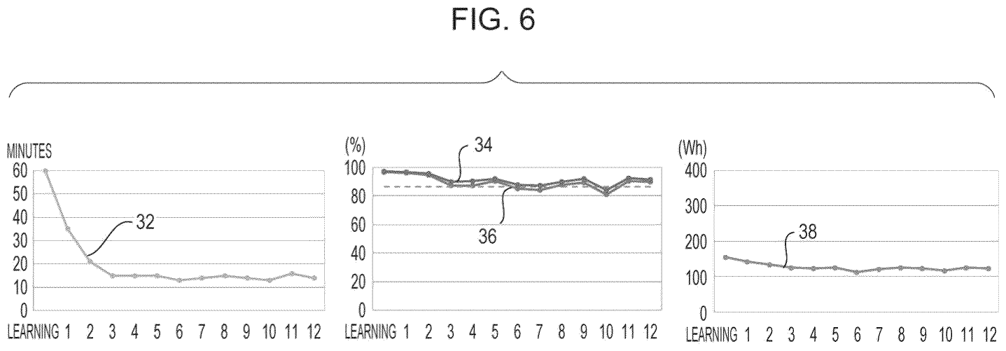

Referring to FIGS. 6 to 8, the results obtained through execution of the process according to the base configuration example described above will be described.

### First Concrete Example

Referring to FIG. 6, a first concrete example will be described. FIG. 6 illustrates the change over time of the SP shift time, the change over time of ratios 1 and 2, and the change over time of the amount of power. The horizontal axis in each graph represents weeks. In the first concrete example, the image forming apparatus 10 is operated 40 times a day between 9:00 and 18:00.

Graph 32 illustrates the change over time of the SP shift time. Graph 34 illustrates the change over time of ratio 1. Graph 36 illustrates the change over time of ratio 2. Graph 38 illustrates the change over time of the amount of power other than the amount of power consumed in execution of jobs.

As illustrated in FIG. 6, use of ratio 1 enables control of shifting the mode of the image forming apparatus 10. In addition, while the ratio is maintained at the target value, reduction of the SP shift time is achieved. For example, the SP shift time is reduced to the range between 14 minutes and 17 minutes with time. The ratio reflects convenience. As a shorter SP shift time is obtained, the mode of the image forming apparatus 10 is shifted to the SP mode at an earlier time point, achieving higher power saving. In the first concrete example, while the target convenience is maintained, power saving is improved. In addition, the amount of power other than the amount of power consumed in execution of jobs is reduced. Specifically, the amount of power is reduced by 22%.

### Second Concrete Example

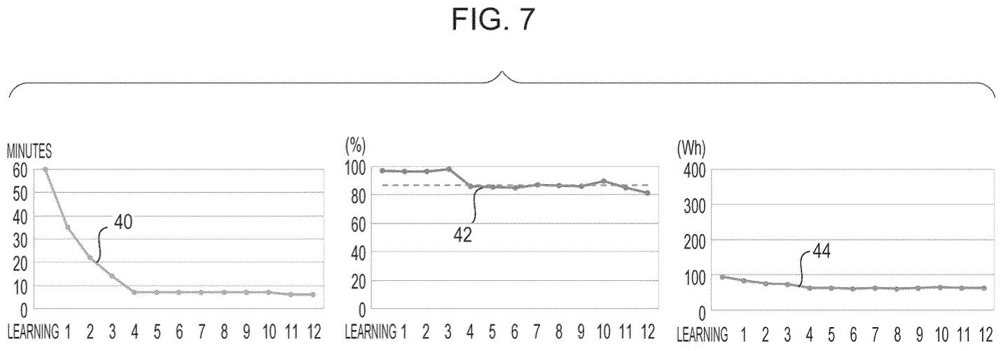

Referring to FIG. 7, a second concrete example will be described. FIG. 7 illustrates the change over time of the SP shift time (Graph 40), the change over time of ratio 1 (Graph 42), and the change over time of the amount of power (Graph 44). The horizontal axis in each graph represents weeks. In the second concrete example, the image forming apparatus 10 is operated 40 times per day between 9:00 and 14:00. In the second concrete example, the image forming apparatus 10 is used intensively in a period shorter than that in the first concrete example.

Also in the second concrete example, substantially the same effects as those in the first concrete example are obtained. In the second concrete example, the SP shift time is reduced to the range between 7 minutes and 8 minutes. The count of processes in the first concrete example is the same as that in the second concrete example. However, in the second concrete example, the image forming apparatus 10 is used intensively in a period shorter than that in the first concrete example. This way of using the image forming apparatus 10 is reflected in the shift time, and the shift time in the second concrete example is shorter than that in the first concrete example. In addition, the amount of power is reduced by 33%.

### Third Concrete Example

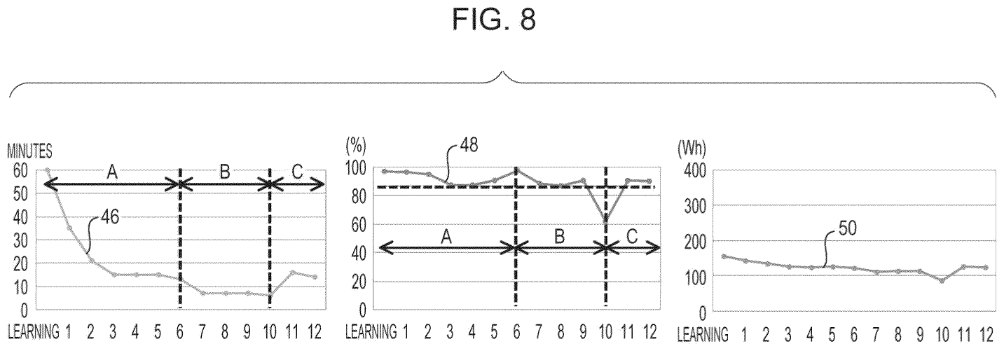

Referring to FIG. 8, a third concrete example will be described. FIG. 8 illustrates the change over time of the SP shift time (Graph 46), the change over time of ratio 1 (Graph 48), and the change over time of the amount of power (Graph 50). The horizontal axis in each graph represents weeks.

In the third concrete example, the way of using the image forming apparatus 10 changes depending on periods. FIG. 8 illustrates Periods A, B, and C. Periods A and C are normal periods. In Period A, the image forming apparatus 10 is used 40 times per day. Period B is a busy period. In Period B, the image forming apparatus 10 is used 80 times per day.

In Period A, the SP shift time is stabilized in the range between 15 minutes and 16 minutes. In Period B, the SP shift time is reduced to the range between 7 minutes and 8 minutes. In Period C, the SP shift time is stabilized in the range between 15 minutes and 16 minutes. Thus, the SP shift time is controlled so as to follow the way of using the image forming apparatus 10. In addition, the amount of power is reduced by 26%.

### MODIFIED EXAMPLES

Modified examples will be described below.

In the above-described base configuration example, ratio 1 or ratio 2 is used as a ratio, but these are merely exemplary ratios, and other ratios may be used. For example, ratio 3 or ratio 4 may be used:

$$ratio 3 \text{:} LP / SP ,$$

$$ratio 4 \text{:} R / ( R + LP + SP ) .$$

For example, ratio 4 may be used when a long time is set to the waiting time used at a return from the LP mode. When the LP shift time is controlled without change of the SP shift time, ratio 4 may be used.

When the ratio of the count of execution of jobs with a relatively short waiting time is relatively high, the processor 20 may calculate the ratio by using the count of execution of jobs performed through operations on the UI 14. When the ratio of the count of execution of jobs with a relatively short waiting time is relatively low, the processor 20 may calculate the ratio by using the count of execution of all jobs.

When the image forming apparatus 10 does not have the LP mode, the processor 20 may calculate the set value of the SP shift time by using ratio 5 described below, and the processor 20 controls the SP shift time:

$$ratio 5 \text{:} R / ( R + SP ) .$$

In the case where the image forming apparatus 10 has a fixing device, when the image forming apparatus 10 has a power saving mode of a fuser of the fixing device, ratio 6 described below may be used:

$$ratio 6 \text{:} ( R + F ) / ( R + F + SP ) ,$$

where F represents the count of returns from the power saving mode of the fuser.

The processor 20 may calculate the ratio by using the count of execution of processes and the time intervals of execution of processes. Specifically, the processor 20 uses the count of processes, which are performed at time intervals which are each within a shift time (for example, the SP shift time), and the total count of processes to calculate ratio 7 described below. A time interval of execution of processes is a time interval from the time point of execution of a certain process till the time of execution of the next process. Use of ratio 7 eliminates necessity of counting processes in each mode. The total count of processes is the total count of processes performed in a learning period or in an automatic control period:
ratio 7: (count of processes performed at time intervals which are each within shift time)/total count of processes.

In the base configuration example and the modified examples described above, the count of processes performed in each mode may be the count of operations on the UI 14 in the mode. Each of R, LP, and SP described above is the count of operations on the UI 14. The processor 20 calculates a ratio (for example, any of ratios 1 to 7) on the basis of the count of operations on the UI 14 in each mode. Typically, when a user is to operate the UI 14, the user moves to the image forming apparatus 10 and operates the UI 14. Through calculation of a ratio based on the count of operations on the UI 14, the ratio is calculated in consideration of convenience in the state in which users, who are actually present at the image forming apparatus 10, operate the image forming apparatus 10. As a result, the set value of the shift time is calculated in consideration of convenience in such a state.

When the count of operations on the UI 14 is less than or equal to a threshold, the processor 20 may calculate a ratio, such as ratios 1 to 7, on the basis of the count including the count of processes (for example, jobs) other than operations on the UI 14. The threshold is a predetermined value. The threshold may be set by a user. For example, when the count of operations on the UI 14 is less than or equal to the threshold, the processor 20 calculates a ratio on the basis of the total of the count of execution of all jobs and the count of operations on the UI 14. That is, each of R, LP, and SP described above is the total of the count of execution of all jobs and the count of operations on the UI 14, and the processor 20 calculates the ratio on the basis of the total in each mode.

### Exemplary Embodiment Including Human Detecting Sensor

The image forming apparatus 10 according to the base configuration example has been described above. This base configuration example does not include a human detecting sensor.

In contrast, there is also known an image processing apparatus that returns from the power saving mode to the ready mode when a person, that is, a user, approaching the image processing apparatus is detected by a human detecting sensor. In this type of image processing apparatus, since the process of returning to the ready mode starts in the stage in which a user is approaching the image processing apparatus, the return to the ready mode is often completed by the time when the user arrives at a position where the user can operate the UI of the image processing apparatus. Even if the return has not been completed, a considerable part of the return process has been completed, and thus the time for which the user is kept waiting in front of the image processing apparatus is short. That is, in many cases, an image processing apparatus including a human detecting sensor makes a user's perceived waiting time, which is required until the image processing apparatus is ready for execution of a process, shorter than that of an image processing apparatus which does not include a human detecting sensor.

Therefore, in the case of an image processing apparatus including a human detecting sensor, even if control is exerted so that the image processing apparatus often enters a mode in which a long time is required until execution of a process is ready, there may be such a way that a user's waiting time will not be so long compared with an image processing apparatus that does not include a human detecting sensor. Such a way may cause improvement of power saving to be expected.

However, mode shift control utilizing such features of an image processing apparatus including a human detecting sensor has not been proposed. Accordingly, an example of such control will be proposed below.

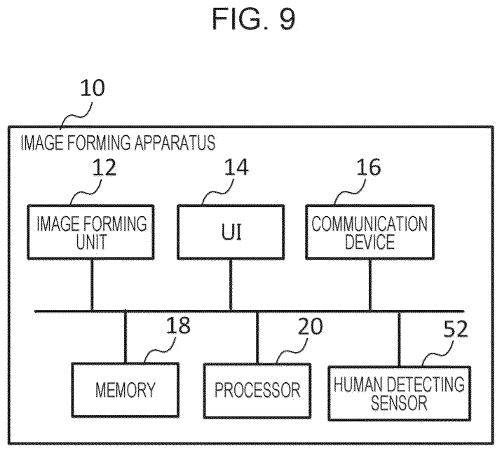

FIG. 9 illustrates the hardware configuration of the image forming apparatus 10 according to the present exemplary embodiment. The image forming apparatus 10 illustrated in FIG. 9 is obtained by adding a human detecting sensor 52 to the image forming apparatus 10 of the base configuration example illustrated in FIG. 1.

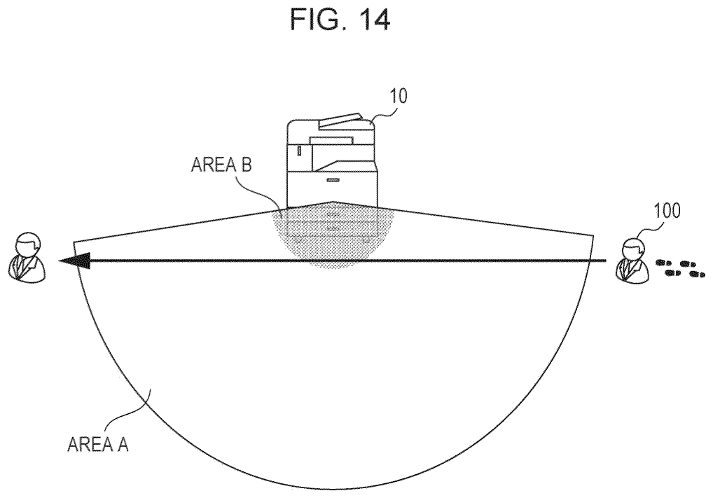

The human detecting sensor 52 is a sensor that detects presence of an object (typically, a person) within a predetermined detection range near the image forming apparatus 10. For example, when viewed from above, the detection ranges of the human detecting sensor 52 are substantially fan-shaped areas (denoted as “area A” and “area B” in FIG. 14) spreading from the installation site of the human detecting sensor 52 of the image forming apparatus 10 as illustrated in FIG. 14, which will be described below.

The type of sensor used as the human detecting sensor 52 is not particularly limited. For example, any sensor such as a pyroelectric sensor, a photoelectric sensor of a reflection type or the like, or various distance sensors (for example, sensors using laser, millimeter waves, ultrasonic waves, and the like) may be used. In addition, the human detecting sensor 52 may be a sensor that is a combination of multiple types of sensors enabling presence of a person to be detected in each of the detection ranges (for example, an area closest to the image forming apparatus 10 and an area outside the closest area), as disclosed in Japanese Unexamined Patent Application Publication No. 2012-114499. In addition, when a distance sensor is used, presence of a person is capable of being detected in each of multiple detection ranges, which have been set, by using a single sensor.

The human detecting sensor 52 is typically disposed on the housing of the main body (that is, a part including a printing mechanism and the like) of the image forming apparatus 10, but is not necessarily disposed on the housing. For example, the human detecting sensor 52 may be disposed on the ceiling, a wall, or the floor of a room in which the image forming apparatus 10 is installed. In either case, the human detecting sensor 52 may be capable of detecting presence of a person within a detection range which is set with reference to the front surface of the image forming apparatus 10 (that is, the surface on which the UI 14 or the like is disposed).

In the above-described base configuration example, in the learning period and the unit control period repeated after the learning period, processes performed in each of the ready mode, the LP mode, and the SP mode (that is, returns) are counted, and the target value is determined based on a ratio obtained from the result of the counts. Then, the set value of a shift time is calculated from the target value, and, in the next unit control period, mode shifts (for example, shifts from the ready mode to the SP mode) are controlled according to the calculated set value of the shift time.

In addition, in order to calculate such a set value of the shift time, in the above-described base configuration example, information about the mode of execution of each process is recorded in the process history in the learning period or unit control periods after the learning period. Alternatively, the ratio and the counts, which serve as the process history, are calculated on the basis of the record of the mode of execution of each process.

In the present exemplary embodiment, detection results from the human detecting sensor 52 are to be reflected in the recording in the process history. That is, the present exemplary embodiment is made in consideration of, not only the mode of the image forming apparatus 10 at the time of request for execution of a process, but also whether the process is performed based on the human detecting sensor 52's detection of a person, that is, a user. That is, whether, in execution of a process, a return from the power saving mode is performed based on the human detecting sensor 52's detection of a user is also considered. Based on both of the mode and information about whether the human detecting sensor 52 detects a person, a mode that is to be recorded as the mode of execution of a process is determined.

In the case where the human detecting sensor 52 detects a user approaching the image forming apparatus 10, when the user arrives at the front of the image forming apparatus 10, a return to the ready mode is completed or almost completed in many cases. Therefore, in such a case, the user, who arrives at the front of the image forming apparatus 10, does not need to wait until execution of a process is ready, or even when the user has to wait, the waiting time is considerably short. Accordingly, in typical control according to the present exemplary embodiment, a process, which is performed based on the human detecting sensor 52's detection of a user, is recorded as a process performed, not in the actual mode of the image forming apparatus 10, but in a predetermined mode having a short waiting time.

The expression, “a process is performed based on the human detecting sensor 52's detection of a user”, typically means that a return from the power saving mode to the ready mode starts due to the human detecting sensor 52's detection of the user acting as a trigger, and that the process is performed in the state in which the ready mode continues after completion of the return. Further, for example, if the time, at which a return to the ready mode is completed, fails to be detected, initiation of a process within a predetermined time from the time of the human detecting sensor 52's detection of a user may be regarded as the state in which “the process is performed based on the human detecting sensor 52's detection of the user”. The “predetermined time” is a short time to such extent that it may be presumed that a process is performed as a result of a user, who has been detected by the human detecting sensor 52, arriving at the front of the image forming apparatus 10 and operating the image forming apparatus 10. The “predetermined time” is determined in advance through an experiment or the like.

The “predetermined mode having a short waiting time” is, for example, the ready mode or the LP mode described above. That is, in the above-described example, the waiting time of each of the ready mode and the LP mode is one second or less, which is significantly shorter than the waiting time (for example, three seconds) of the SP mode.

### First Control Example

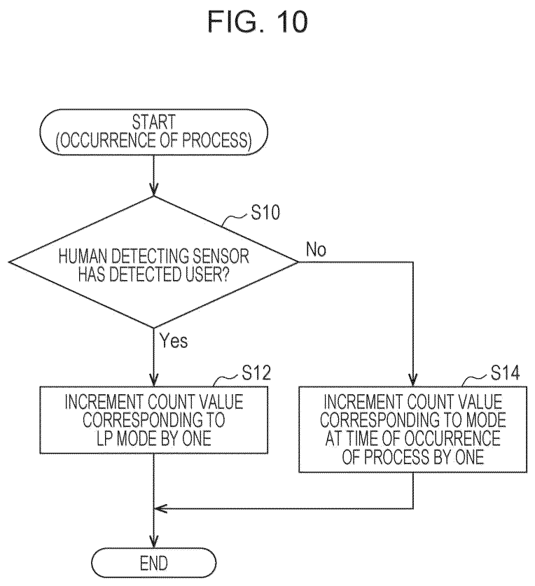

Exemplary control according to the present exemplary embodiment will be described below by referring to FIG. 10. The control procedure illustrated in FIG. 10 starts when a job or the like occurs.

Occurrence of a process that triggers execution of the control procedure is, for example, actual start of execution of the process such as a job. In addition, in an example of use of the above-described simplified ratio (that is, ratio 2), a return from the LP mode or the SP mode to the ready mode may be regarded as occurrence of a process. In this case, the processor 20 may determine “occurrence of a process” only by using a mode-shifting control program without determining whether the process such as a job has actually been performed.

In the procedure in FIG. 10, when a process occurs, the processor 20 determines whether the human detecting sensor 52 has detected a user immediately before occurrence of the process (S10).

The processor 20, for example, periodically determines whether a user is present within the detection range of the human detecting sensor 52 based on the signal from the human detecting sensor 52, which is not illustrated in FIG. 10. Then, when a user is detected in the detection range for the first time after the state in which any user is not detected in the detection range, the processor 20 exerts control so that the image forming apparatus 10 returns from the power saving mode (for example, the LP mode or the SP mode) to the ready mode. In such control, the processor 20 may recognize that, immediately after the human detecting sensor 52 detects of a user, the user's operation causes occurrence of a process. The expression, “immediately after the human detecting sensor 52 detects a user”, typically refers to a period during which the ready mode continues as a result of completion of a return from the power saving mode to the ready mode, which starts due to the human detecting sensor 52's detection of the user acting as a trigger. Further, in another example, the expression, “immediately after the human detecting sensor 52 detects a user”, means being within the time considered to be required from when the user is detected for the first time at the outer periphery of the detection range of the human detecting sensor 52, to when the user, who has walked and arrived at the front of the image forming apparatus 10, operates the UI 14. This time is determined and set in advance through an experiment or the like.

If the result of the determination in step S10 is Yes, the processor 20 increments the count value corresponding to the LP mode by one (S12). In contrast, if the result of the determination in step S10 is No, the processor 20 increments the count value corresponding to the mode at the time of occurrence of the process by one (S14).

The mode at the time of occurrence of a process is a mode immediately before occurrence of the process acting as a trigger of the procedure in FIG. 10. For example, the image forming apparatus 10 in the LP mode or the SP mode returns to the ready mode in order to perform a process. In this case, the LP mode or the SP mode immediately before the return to the ready mode is the mode at the time of occurrence of the process in this example. In the above description about ratios 1 and 2, for example, “the count of execution of processes in the LP mode”, “the count of execution of processes in the SP mode”, and the like are used. These may be translated into the count of processes which occurred in the LP mode and the count of processes which occurred in the SP mode.

Steps S12 and S14 will be described in more detail. In the present exemplary embodiment, at least two counters are used to calculate ratio 1 or ratio 2 described above.

In one example, two counters, that is, a first counter, which holds the count of execution of processes in the mode in which the waiting time is less than or equal to a threshold, and a second counter, which holds the total of counts of execution of processes, are used. The threshold in this case indicates the length of a user-allowable waiting time, and is, for example, one second as described above. A waiting time less than or equal to the threshold indicates high user convenience. In the case of use of ratio 1, the first counter holds the value of (R+LP), and the second counter holds the value of (R+LP+SP). In the case of use of ratio 2, the first counter holds the value of LP, and the second counter holds the value of (LP+SP). In this example, the value of the first counter is incremented by one in step S12, and the value of the second counter is incremented by one in step S14.

Use of two such counters is only an example. Of course, a counter may be prepared for each mode such as the ready mode, the LP mode, and the SP mode. In this case, the processor 20 may calculate ratio 1 or ratio 2 by using combinations of the values of the counters for the respective modes. In this example, in step S12, the value of the counter of the LP mode is incremented by one, and in step S14, the value of the counter of the mode at the time of occurrence of a process is incremented by one.

As described above, according to the procedure of the first control example, even when the mode at the time of occurrence of a process is the SP mode, if the human detecting sensor 52 detects a user (that is, if the determination result in S10 is Yes), the process is counted as execution in the LP mode.

The processor 20 performs the procedure in FIG. 10 each time occurrence of a process is detected during the learning period and the unit control periods, and increments the corresponding counter. Incrementing the count value of the corresponding counter in step S12 and S14 is an exemplary process of recording the history record of the process. At the time of completion of each of the learning period and the unit control periods, the processor 20 calculates ratio 1 or ratio 2 according to the above-described defined expression by using the value of each counter, determines the target value based on the calculation result, and calculates the set value of the shift time corresponding to the target value.

In the first control example, in step S12, when the human detecting sensor 52 has detected a user, the value of the first counter corresponding to the LP mode is incremented. This is because the process of returning to the ready mode starts when the human detecting sensor 52 detects a user and it is expected that the return is completed or almost completed by the time when the user arrives at the front of the image forming apparatus 10. If the return to the ready mode is almost completed, the user, who has arrived at the front of the image forming apparatus 10, may operate the UI 14 and request execution of a process almost without waiting.

In contrast, for example, in the case where the human detecting sensor 52 has a blind spot due to the installation location of the image forming apparatus 10, a user, who has approached the image forming apparatus 10 in the blind spot, may operate the image forming apparatus 10 without being detected by the human detecting sensor 52. In addition, when a user puts on clothes of a color, a material, or a texture which is difficult to be detected by the human detecting sensor 52, the user may arrive at the image forming apparatus 10 without being detected by the human detecting sensor 52, and may cause the image forming apparatus 10 to perform a process. When a process occurs in the image forming apparatus 10 even though the human detecting sensor 52 does not detect a user, the image forming apparatus 10 behaves similarly to the case of the above-described base configuration example which does not include the human detecting sensor 52. Therefore, in this case, in the process in FIG. 10, in step S14, the value of the counter corresponding to the mode at the time of occurrence of a process is incremented.

The method of recording the history in the present exemplary embodiment is not limited to the method of incrementing the count values, which is illustrated in FIG. 10 and the like. More directly speaking, a method may be adopted in which a value indicating the mode at the time of occurrence of a process is recorded in the history in association with, for example, the date and time of occurrence of the process.

### Second Control Example

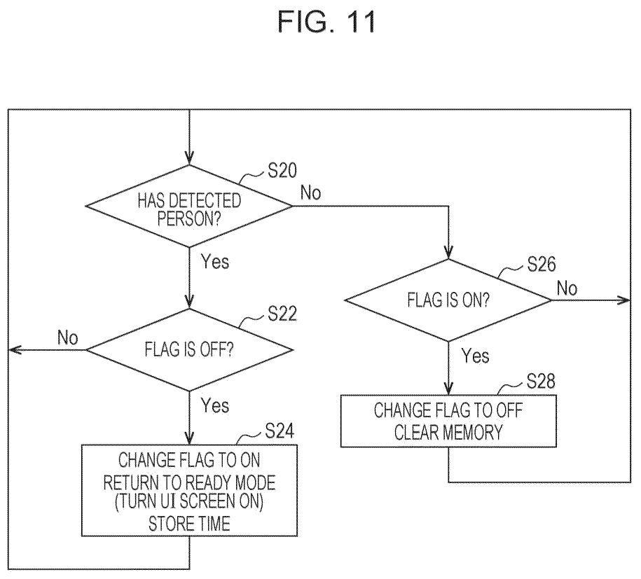

Next, another example of the control in the present exemplary embodiment will be described by referring to FIGS. 11 to 13.

In the above-described first control example (see FIG. 10), it is assumed that, if the human detecting sensor 52 detects a user, a return to the ready mode is completed by the time when the user arrives at the front of the image forming apparatus 10, and the user hardly experiences a waiting time.

However, actually, the assumption may not hold due to various circumstances. For example, when a user approaches the image forming apparatus 10 in a hurry, a return to the ready mode may not be in time. In addition, in the case where a seat is present within the detection range of the human detecting sensor 52, the human detecting sensor 52 reacts to the seat or a user sitting on the seat. This causes the image forming apparatus 10 to be always in the ready mode, resulting in difficulty in achieving power saving. Therefore, some control systems using the human detecting sensor 52 have a function of ignoring a stationary object within the detection range. In the case of using this type of control system, when a user sitting on a seat stands up and approaches the image forming apparatus 10, the human detecting sensor 52 detects the user, but the time from the detection to arrival of the user at the image forming apparatus 10 is short. For this reason, the user, who arrives at the image forming apparatus 10, may wait for a long time until completion of a return to the ready mode.

A second control example is an improvement of the first control example in consideration of such a situation.

FIG. 11 illustrates a procedure of a control system using the human detecting sensor 52 in the second control example. In this procedure, a binary flag indicating whether the human detecting sensor 52 has detected a user is used. The value of the flag is ON when a user is detected, and is OFF when a user is not detected.

For example, the processor 20 periodically monitors the signal from the human detecting sensor 52, and determines whether the signal indicates that a user has been detected at the time of each monitoring (S20). If the result of this determination is Yes, the processor 20 determines whether the value of the above-described flag is OFF (S22).

If the determination result in step S22 is Yes, it means that the human detecting sensor 52 did not detect any user at the previous time point of monitoring, and that the human detecting sensor 52 has detected a new user at the current time point of monitoring. In this case, the processor 20 changes the value of the flag to ON, starts returning the mode of the image forming apparatus 10 to the ready mode, and stores the current time (S24). If the image forming apparatus 10 is already in the ready mode at the time when the result in step S22 is determined to be Yes, returning to the ready mode is not performed in S24, which is not illustrated in FIG. 11 to avoid complexity. After step S24, when the next time point of monitoring comes, the processor 20 returns to step S20, and repeats the subsequent processes.

If the determination result in step S22 is No, that is, the value of the flag is ON, it means that the human detecting sensor 52 has already detected the user in the previous monitoring, and thus the processor 20 skips step S24 and returns to step S20 at the next time point of monitoring.

If the signal from the human detecting sensor 52 at a certain time point of monitoring indicates that a user is not detected, the processor 20 determines whether the value of the flag is ON (S26). If the result of this determination is Yes, the processor 20 changes the value of the flag to OFF, and deletes the stored time (S28). If the result of the determination in step S26 is No, the processor 20 skips step S28 and returns to step S20 at the next time point of monitoring.

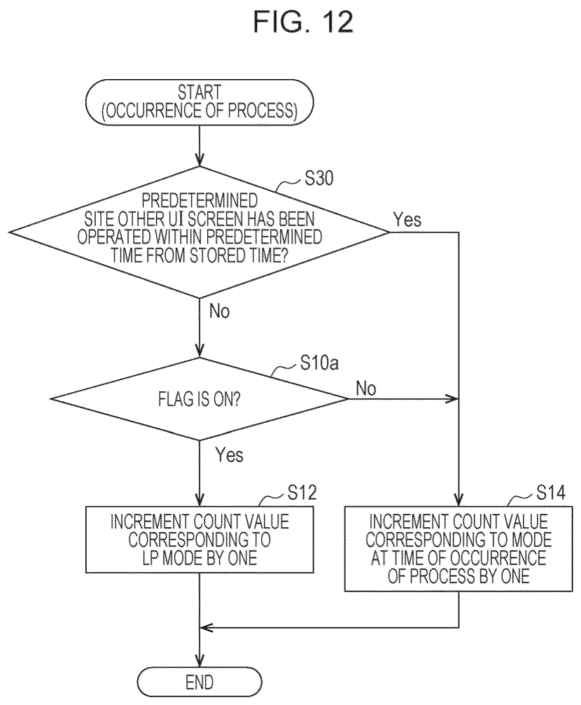

FIG. 12 illustrates an exemplary procedure at the time of occurrence of a process, in the second control example. Among the steps of the procedure illustrated in FIG. 12, the same steps as those of the procedure illustrated in FIG. 10 are denoted by the same reference numerals. In the procedure in FIG. 12, step S30 is added to the procedure in FIG. 10.

In this procedure, when a process occurs, the processor 20 determines whether a user has operated any of one or more predetermined sites other than the UI 14 within a predetermined length of time from the time stored in step S24 described above (S30). The “predetermined length of time” in this determination is the length of time required from a time when a return from the power saving mode to the ready mode starts to a time when the UI 14 enters the display state due to the return. This length is determined in advance through an experiment or the like, and is held in the image forming apparatus 10. When there are multiple types of power saving mode, such as the LP mode and the SP mode described above, the “predetermined length of time” may be used differently for each type. For example, when the mode of the image forming apparatus 10 at the time of occurrence of a process is the SP mode, in step S30, the determination is performed by using the “predetermined length of time” prepared for the SP mode.

In the LP mode and the SP mode, the UI 14, which is constituted, for example, by a touch panel, is in the OFF state, that is, the state in which the screen is not displayed and in which no input from a user is detected. A return to the ready mode causes the UI 14 to be turned on. Thus, the screen of the UI 14 is displayed, and an input from a user to the screen is detectable. The image forming apparatus 10 includes, in addition to the UI 14, sites for receiving an operation or an action from a user. Examples of such a site include an automatic document feeding mechanism, a document cover, a power saving return key, and an integrated circuit (IC) card reader.

A user may perform an operation of placing a document on the automatic document feeding mechanism. Placement of a document is detected by a sensor provided in the mechanism, which is transmitted to the processor 20.

The document cover is an openable and closable cover that covers a glass surface on which a document to be scanned is placed. A user may open or close the document cover. When a user wants to scan a document, the user opens the document cover to expose the glass surface, places the document on the glass surface, and then closes the document cover. The closed document cover presses and fixes the document on the glass surface from above. In this fixed state, the document is scanned. Many image forming apparatuses 10 have a document cover integrated with an automatic document feeding mechanism.

The power saving return key is a key (or a button) for receiving an instruction to return from the power saving mode. When a user presses the power saving return key, the image forming apparatus 10 returns from the power saving mode to the ready mode. As a result, when the return is completed, the UI 14 is turned on, and the user may input an instruction to the screen displayed on the UI 14 through a touch operation or the like.

The IC card reader is a reader device that reads an IC card serving as an identification card of each user. The IC card reader is used to achieve the purpose of limiting use of the image forming apparatus 10 to only users who have been registered in advance or of recording which user has caused the image forming apparatus 10 to perform what kind of process at what time. That is, when a user holds an IC card, which is their identification card, over an IC card reader attached to the image forming apparatus 10, the image forming apparatus 10 recognizes the user identification number of the user through communication with the IC card. This enables the user to use the image forming apparatus 10.

In the case where a return to the ready mode is not completed when a user, who has been detected by the human detecting sensor 52, arrives at the image forming apparatus 10, the UI 14 is in the OFF state, and the user is not allowed to operate the UI 14. In such a case, the user may perform another executable operation while waiting for the UI 14 to be turned on. Examples of such an operation include placing a document on the automatic document feeding mechanism, opening the document cover, pressing the power saving return key, and holding an IC card over the IC card reader. For example, the case where the IC card reader reads an IC card immediately after the IC card reader enters the operating state after a return from the power saving mode to the ready mode means the state in which the user has held the IC card over the IC card reader before completion of the return to the ready mode.

If the determination result in step S30 is Yes, it means that the user may not have been able to wait for the UI 14 to be turned on. In this case, although the human detecting sensor 52 detects the user, the processor 20 increments the value of the counter corresponding to the mode at the time of occurrence of the process (S14). In the procedure in FIG. 10, if the human detecting sensor 52 detects the user (that is, if the determination result in step S10 is Yes), step S12 is performed. In contrast, in the second control example, even when the human detecting sensor 52 detects a user, if the determination result in step S30 is Yes, step S14 is performed.

In step S12, the value of the first counter that holds the count of execution of processes in the mode in which the waiting time is less than or equal to the threshold is incremented. However, in the case where it is determined in step S30 that a user may not have been able to wait, it is inappropriate to increment the first counter unconditionally just because the human detecting sensor 52 has detected the user. Therefore, in this second control example, in such a case, step S14 is performed instead of step S12. Thus, in the case where the determination result in step S30 is Yes, if the mode at the time of occurrence of a process is, for example, the SP mode, the current process is counted as the count value of the second counter. In contrast, even when the mode at the time of occurrence of a process is, for example, the ready mode and the UI 14 is in the ON state, the user may operate any of the sites, described above, before operating the UI 14. This case indicates no reduction of the user convenience. Thus, the process may be counted as execution in the ready mode.

If the determination result in step S30 is No, the processor 20 determines whether the value of the flag is ON (S10a). If a user has been detected by the human detecting sensor 52, the determination result in step S10a is Yes. If not, the determination result is No. This determination has the same meaning as step S10 in the procedure in FIG. 10. If the determination result in step S10a is Yes, step S12 is performed. If the determination result is No, step S14 is performed.

According to the procedure of the second control example, even when the mode at the time of occurrence of a process is the SP mode and the determination result in S10a is Yes, if the determination result in step S30 is Yes, the process is counted as execution in the SP mode.

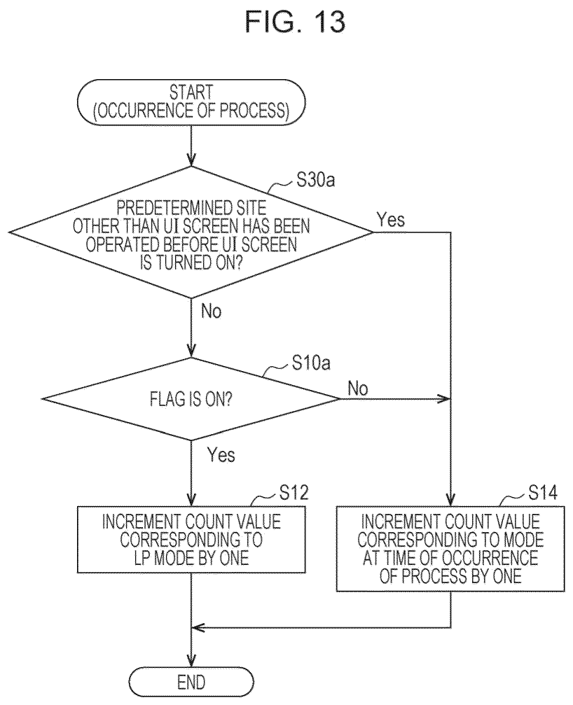

A procedure illustrated in FIG. 13 is a modified example of the procedure in FIG. 12. In the procedure illustrated in FIG. 13, step S30 in the procedure in FIG. 12 is replaced by step S30a. That is, in the procedure in FIG. 12, it is determined whether a predetermined site other than the UI 14 is operated within the predetermined time from when the human detecting sensor 52 detects a user for the first time (S30). In contrast, in the procedure in FIG. 13, it is determined whether a user has operated any of one or more predetermined sites other than the UI 14 before the UI 14 is turned on (S30a).

### Third Control Example

A third control example of the present exemplary embodiment will be described by referring to FIGS. 14 to 17.

The third control example is intended to solve a problem that may occur when the above-described simplified ratio (that is, ratio 2) is used. First, a problem that may occur when the simplified ratio is used will be described by referring to FIG. 14.

FIG. 14 illustrates the case where the human detecting sensor 52 (not illustrated) of the image forming apparatus 10 has two large and small detection ranges (denoted as areas A and B in FIG. 14). The areas A and B are fan-shaped areas when viewed from above. The area B is an area extremely close to the front surface of the image forming apparatus 10. A user in the area B may touch and operate the UI 14 of the image forming apparatus 10. The area A has a radius larger than that of the area B. The radius of the area A is determined so that, for example, the time for a user, who walks at a normal walking speed, to walk the length of the radius is substantially equal to the time required for the image forming apparatus 10 to return from the SP mode to the ready mode.

In this example, returning from the SP mode to the ready mode is divided into two stages. In the first stage, the power supply (which supplies power to, for example, the UI 14 or the like), which is stopped in the SP mode for power saving, is restarted. When a user is detected for the first time by the human detecting sensor 52 in the area A, the process in the first stage starts. In the second stage, power is supplied to each unit, which is to be operated in the ready mode, such as the UI 14, and each unit shifts to the ON state. When the user enters the area B, the second stage starts, and the image forming apparatus 10 shifts to the ready mode.

FIG. 14 illustrates a state in which a user 100 passes by the front surface of the image forming apparatus 10 along a path indicated by the arrow. In this example, the user 100 simply passes by the image forming apparatus 10 without using the image forming apparatus 10. Even in this case, since the user 100 enters the area B once after entering the area A, the image forming apparatus 10 returns to the ready mode. When the simplified ratio is used, the return to the ready mode is regarded as occurrence of a process, and is reflected in the count value of the first counter or the second counter used for calculation of the ratio. However, in this example, since the user 100 does not use the image forming apparatus 10, a process does not occur. Therefore, reflecting the return to the ready mode in the count value increases inaccuracy of the calculated simplified ratio.

Therefore, in the third control example, the following control is performed in order to reduce such inaccuracy.

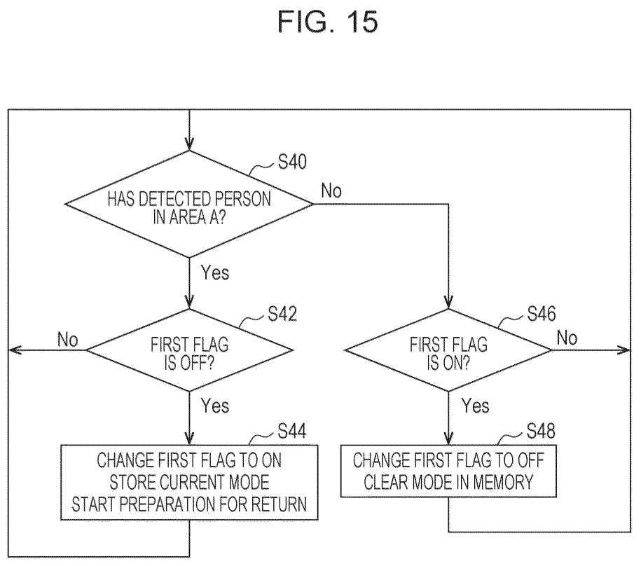

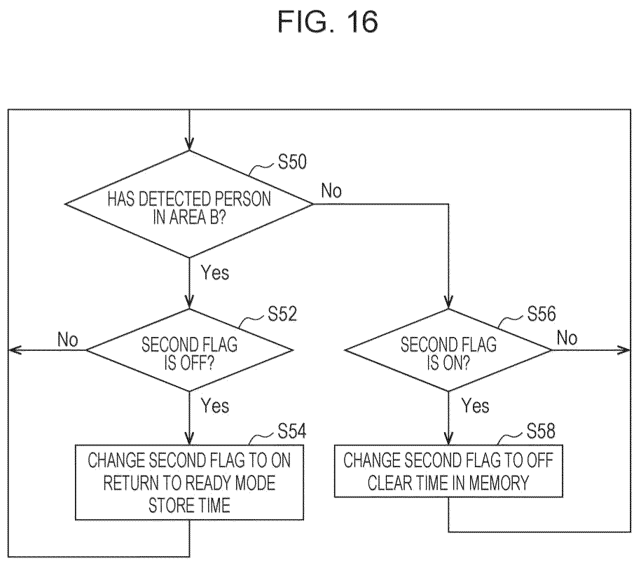

FIGS. 15 and 16 illustrate an example of a procedure of the control system using the human detecting sensor 52 in the third control example. In this example, the processor 20 performs the process illustrated in FIG. 15 on the result of the human detecting sensor 52's detection of a user in the area A, and performs the process illustrated in FIG. 16 on the result of detection of a user in the area B.

In the procedure in FIG. 15, the processor 20 periodically monitors the signal from the human detecting sensor 52 and determines whether the human detecting sensor 52 has detected a user in the area A (S40). If the result of this determination is Yes, the processor 20 determines whether the value of a first flag is OFF (S42). The first flag is a flag used to store whether a user is present in the area A.

If the result of the determination in step S42 is Yes, the processor 20 changes the value of the first flag to ON, stores the current mode in the memory 18, and prepares for a return to the ready mode, that is, starts the first stage of a return described above (S44). The mode stored in step S44 is a mode immediately before a return to the ready mode, and has the same meaning as the mode at the time when a process occurs in the image forming apparatus 10.

After step S44, the processor 20 returns to step S40 at the next time point of monitoring, and performs the subsequent processes repeatedly. If the determination result in step S42 is No, the processor 20 skips step S44 and returns to step S40 at the next time point of monitoring.

If the human detecting sensor 52 does not detect a user, the processor 20 determines whether the value of the first flag is ON (S46). If the result of this determination is Yes, the processor 20 changes the value of the first flag to OFF and clears the mode stored in S44 (S48). Then, the process returns to step S40. If the result of the determination in step S46 is No, the processor 20 skips step S48 and returns to step S40 at the next time point of monitoring.

In the procedure in FIG. 16, the processor 20 periodically monitors the signal from the human detecting sensor 52, and determines whether the human detecting sensor 52 has detected a user in the area B (S50). If the result of this determination is Yes, the processor 20 determines whether the value of a second flag is OFF (S52). The second flag is a flag used to store whether a user is present in the area B.

If the determination result in step S52 is Yes, the processor 20 changes the value of the second flag to ON, performs a return to the ready mode, that is, performs the second stage described above, and stores the current time (S54). The time when a user is detected for the first time in the area B is stored as the time when a process occurs in the image forming apparatus 10. After step S54, the processor 20 returns to step S50 at the next time point of monitoring, and performs the subsequent processes repeatedly. If the determination result in step S52 is No, the processor 20 skips step S54 and returns to step S50 at the next time point of monitoring. In the example in FIGS. 15 and 16, the processor 20 stores the current time in step S54. Alternatively, instead of this, in step S44, the processor 20 may store the current time (that is, the time when a user is detected in the area A for the first time) as the time of occurrence of a process.

If the human detecting sensor 52 does not detect a user, the processor 20 determines whether the value of the second flag is ON (S56). If the result of this determination is Yes, the processor 20 changes the value of the second flag to OFF, and clears the time stored in S54 (S58). Then, the process returns to step S50. If the result of the determination in step S56 is No, the processor 20 skips step S58 and returns to step S50 at the next time point of monitoring.

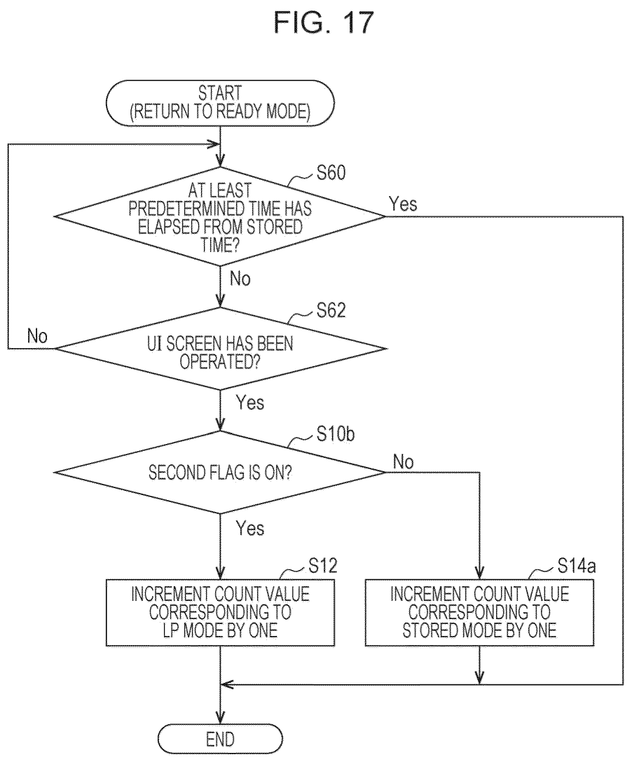

FIG. 17 illustrates an exemplary procedure at the time of a return to the ready mode in the third control example. In the procedure in FIG. 17, steps, which are the same as or similar to those of the procedure in FIGS. 10 and 12, are denoted by the reference numerals same as or similar to those of the steps in FIG. 10.

In the third control example, the ready mode is an exemplary executable mode in which execution of a process is ready. The LP mode is an exemplary first power saving mode in which the time required for a return to the executable mode is within a predetermined threshold, and the SP mode is an exemplary second power saving mode in which the time required for a return to the executable mode is longer than the threshold.

In this procedure, in response to a return to the ready mode, the processor 20 determines whether at least a predetermined threshold time has elapsed from the time (that is, the time of the return to the ready mode) stored in step S54 at the time of the return (S60). If the determination result is No, that is, if the threshold time has not elapsed from the stored time, the processor 20 determines whether the user has operated the UI 14 (S62). In response to a shift to the ready mode, the UI 14 is turned on, and the user is allowed to input an operation to the screen of the UI 14. In the third control example, not only occurrence of a return to the ready mode, but also detection of a user's operation on the UI 14 causes the processor 20 to determine that a process has been performed in the image forming apparatus 10.

If the determination result in step S62 is Yes, the processor 20 determines whether the value of the second flag is ON (S10b). If the result of this determination is Yes, the processor 20 increments the count value corresponding to the LP mode (S12). In contrast, if the determination result in step S10b is No, the processor 20 increments the count value corresponding to the mode stored in S44 of the procedure in FIG. 15 (S14a). If step S12 or S14a is finished, the procedure in FIG. 17 ends.

If the determination result in step S62 is No, the processor 20 returns to the process in step S60.

When at least the predetermined threshold time has elapsed from the time of the return to the ready mode without detection of the user's operation on the UI 14 (the determination result in step S60 is Yes), the processor 20 ends the procedure in FIG. 17. In this case, since neither step S12 nor S14a is performed, neither counter is incremented. That is, when a user simply passes just by the image forming apparatus 10 without using the image forming apparatus 10, the determination result in step S60 is Yes, and none of the counters is incremented.

Some of the functions of the image forming apparatus 10 of the base configuration example and the exemplary embodiment described above may be implemented by an apparatus other than the image forming apparatus 10. When some functions of the image forming apparatus 10 are implemented by a different apparatus other than the image forming apparatus 10, the image forming apparatus 10 and the different apparatus may be included in an information processing system. That is, the functions of the image forming apparatus 10 may be implemented in a single apparatus, or may be implemented in the information processing system including multiple apparatuses.

For example, each function of the image forming apparatus 10 is implemented in cooperation with hardware and software. For example, the processor 20 of the image forming apparatus 10 reads, for execution, programs stored in a memory. Thus, each function of the image forming apparatus 10 is implemented. The programs are stored in a memory through a recording medium, such as a compact disc (CD) or a digital versatile disc (DVD), or through a communication path such as a network. Similarly, the processor 20 of the image forming apparatus 10 reads, for execution, programs stored in a memory. Thus, each function of the image forming apparatus 10 is implemented. The programs are stored in a memory through a recording medium, such as a CD or a DVD, or through a communication path such as a network.

In the exemplary embodiment and the modified examples described above, control of the mode of the image forming apparatus 10 is described. The processes according to the exemplary embodiment and the modified examples may be applied to an apparatus other than the image forming apparatus 10. That is, an apparatus according to the exemplary embodiment and its modified examples may be other than the image forming apparatus 10 as long as the apparatus has multiple modes having different times elapsing until execution of a process is ready.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

### APPENDIX

(((1)))

An information processing system comprising:
a processor for an apparatus having a plurality of modes having different times until execution of a process is ready, the processor being configured to:
   determine a mode that is to be recorded in a history as a mode at a time of execution of a process, the determining being performed based on a mode at the time of the apparatus's execution of the process and whether the process is performed based on a human detecting sensor's detection of a user;
   record the determined mode in the history; and
   output a set value of a shift time elapsing until the apparatus shifts to a mode in which a time until execution of a process is ready is longer than in another mode among the plurality of modes, the outputting being performed based on a count of processes performed in a specific mode, the count of processes being obtained based on the history.
      (((2)))

The information processing system according to (((1))),
wherein, in the outputting of the set value of the shift time, the processor is configured to:
   based on a ratio of the count of processes performed in the specific mode, the count of processes being obtained based on the history, set a target value of the ratio; and
   based on the set target value, output the set value of the shift time elapsing until the apparatus shifts to the mode in which the time until execution of a process is ready is longer than another mode among the plurality of modes.
      (((3)))

The information processing system according to (((1))),
wherein the plurality of modes include a first mode and a second mode, the second mode being a mode in which a time until execution of a process is ready is longer than in the first mode, and
wherein, in the determining, when the mode at the time of the apparatus's execution of the process is the second mode, if the process is performed based on the human detecting sensor's detection of the user, the mode recorded in the history as the mode at the time of execution of the process is determined to be the first mode, and, if the process is not performed based on the human detecting sensor's detection of the user, the mode recorded in the history as the mode at the time of execution of the process is determined to be the second mode.
   (((4)))

The information processing system according to (((3))),
wherein, in the determining, when the mode at the time of the apparatus's execution of the process is the second mode, even if the process is performed based on the human detecting sensor's detection of the user, in response to the user operating a predetermined operable site of the apparatus within a predetermined time from the human detecting sensor's detection of the user, the predetermined operable site being other than a user interface screen, the mode recorded in the history as the mode at the time of execution of the process is determined to be the second mode.
   (((5)))

The information processing system according to (((3))),
wherein, in the determining, when the mode at the time of the apparatus's execution of the process is the second mode, even if the process is performed based on the human detecting sensor's detection of the user, in response to the user operating a predetermined operable site of the apparatus before display of a user interface screen of the apparatus, the predetermined operable site being other than the user interface screen, the mode recorded in the history as the mode at the time of execution of the process is determined to be the second mode.
   (((6))

The information processing system according to (((4))) or ((5))),
wherein the user's operation on the predetermined operable site other than the user interface screen includes at least one of placement of a document on an automatic document feeding mechanism, an operation of opening a document cover, pressing of a power saving return key, and an operation of holding an IC card over an IC card reader.
   (((7)))

The information processing system according to (((2))),
wherein the plurality of modes include an executable mode in which execution of a process is ready, a first power saving mode in which a time required for a return to the executable mode is within a predetermined threshold, and a second power saving mode in which a time required for a return to the executable mode is greater than the threshold,
wherein power supply to a user interface screen of the apparatus is stopped in the first power saving mode and the second power saving mode, and power supply to the user interface screen is performed in the executable mode,
wherein the processor is configured to:
   when, based on the detection using the human detecting sensor, it is determined that the user approaches the user interface screen of the apparatus and arrives at a position where the user is able to use the user interface screen, if the mode of the apparatus at that time is the first power saving mode or the second power saving mode, return the apparatus to the executable mode; and
   regard a return from the first power saving mode or the second power saving mode to the executable mode as the apparatus's execution of a process, and perform the determining by regarding the first power saving mode or the second power saving mode just before the return, as the mode at the time of the apparatus's execution of the process, and
wherein the ratio of the count of processes performed in the specific mode is a ratio obtained from the count of processes which are performed in the first power saving mode and which are recorded in the history and the count of processes which are performed in the second power saving mode and which are recorded in the history,
wherein the processor is configured to:
   when the user does not operate the user interface screen within a predetermine time after the return from the first power saving mode or the second power saving mode to the executable mode, not regard the return as the apparatus's execution of a process, and not record the mode for the return in the history.
      (((8)))

A program causing a computer to execute a process comprising:
for an apparatus having a plurality of modes having different times until execution of a process is ready,
determining a mode that is to be recorded in a history as a mode at a time of execution of a process, the determining being performed based on a mode at the time of the apparatus's execution of the process and whether the process is performed based on a human detecting sensor's detection of a user;
recording the determined mode in the history; and
outputting a set value of a shift time elapsing until the apparatus shifts to a mode in which a time until execution of a process is ready is longer than in another mode among the plurality of modes, the outputting being performed based on a count of processes performed in a specific mode, the count of processes being obtained based on the history.
   (((9)))

A method for an apparatus having a plurality of modes having different times until execution of a process is ready, the method comprising:
determining a mode that is to be recorded in a history as a mode at a time of execution of a process, the determining being performed based on a mode at the time of the apparatus's execution of the process and whether the process is performed based on a human detecting sensor's detection of a user;
recording the determined mode in the history; and
outputting a set value of a shift time elapsing until the apparatus shifts to a mode in which a time until execution of a process is ready is longer than in another mode among the plurality of modes, the outputting being performed based on a count of processes performed in a specific mode, the count of processes being obtained based on the history.

What is claimed is:

1. An information processing system comprising:
a processor for an apparatus having a plurality of modes having different times until execution of a process is ready, the processor being configured to:
determine a mode that is to be recorded in a history as a mode at a time of execution of a process, the determining being performed based on a mode at the time of the apparatus's execution of the process and whether the process is performed based on a human detecting sensor's detection of a user;
record the determined mode in the history; and
output a set value of a shift time elapsing until the apparatus shifts to a mode in which a time until execution of a process is ready is longer than in another mode among the plurality of modes, the outputting being performed based on a count of processes performed in a specific mode, the count of processes being obtained based on the history.

2. The information processing system according to claim 1,
wherein, in the outputting of the set value of the shift time, the processor is configured to:
based on a ratio of the count of processes performed in the specific mode, the count of processes being obtained based on the history, set a target value of the ratio; and
based on the set target value, output the set value of the shift time elapsing until the apparatus shifts to the mode in which the time until execution of a process is ready is longer than another mode among the plurality of modes.

3. The information processing system according to claim 1,
wherein the plurality of modes include a first mode and a second mode, the second mode being a mode in which a time until execution of a process is ready is longer than in the first mode, and
wherein, in the determining, when the mode at the time of the apparatus's execution of the process is the second mode, if the process is performed based on the human detecting sensor's detection of the user, the mode recorded in the history as the mode at the time of execution of the process is determined to be the first mode, and, if the process is not performed based on the human detecting sensor's detection of the user, the mode recorded in the history as the mode at the time of execution of the process is determined to be the second mode.

4. The information processing system according to claim 3,
wherein, in the determining, when the mode at the time of the apparatus's execution of the process is the second mode, even if the process is performed based on the human detecting sensor's detection of the user, in response to the user operating a predetermined operable site of the apparatus within a predetermined time from the human detecting sensor's detection of the user, the predetermined operable site being other than a user interface screen, the mode recorded in the history as the mode at the time of execution of the process is determined to be the second mode.

5. The information processing system according to claim 3,
wherein, in the determining, when the mode at the time of the apparatus's execution of the process is the second mode, even if the process is performed based on the human detecting sensor's detection of the user, in response to the user operating a predetermined operable site of the apparatus before display of a user interface screen of the apparatus, the predetermined operable site being other than the user interface screen, the mode recorded in the history as the mode at the time of execution of the process is determined to be the second mode.

6. The information processing system according to claim 4,
wherein the user's operation on the predetermined operable site other than the user interface screen includes at least one of placement of a document on an automatic document feeding mechanism, an operation of opening a document cover, pressing of a power saving return key, and an operation of holding an IC card over an IC card reader.

7. The information processing system according to claim 5,
wherein the user's operation on the predetermined operable site other than the user interface screen includes at least one of placement of a document on an automatic document feeding mechanism, an operation of opening a document cover, pressing of a power saving return key, and an operation of holding an IC card over an IC card reader.

8. The information processing system according to claim 2,
wherein the plurality of modes include an executable mode in which execution of a process is ready, a first power saving mode in which a time required for a return to the executable mode is within a predetermined threshold, and a second power saving mode in which a time required for a return to the executable mode is greater than the threshold,
wherein power supply to a user interface screen of the apparatus is stopped in the first power saving mode and the second power saving mode, and power supply to the user interface screen is performed in the executable mode,
wherein the processor is configured to:
when, based on the detection using the human detecting sensor, it is determined that the user approaches the user interface screen of the apparatus and arrives at a position where the user is able to use the user interface screen, if the mode of the apparatus at that time is the first power saving mode or the second power saving mode, return the apparatus to the executable mode; and
regard a return from the first power saving mode or the second power saving mode to the executable mode as the apparatus's execution of a process, and perform the determining by regarding the first power saving mode or the second power saving mode just before the return, as the mode at the time of the apparatus's execution of the process, and
wherein the ratio of the count of processes performed in the specific mode is a ratio obtained from the count of processes which are performed in the first power saving mode and which are recorded in the history and the count of processes which are performed in the second power saving mode and which are recorded in the history,
wherein the processor is configured to:
when the user does not operate the user interface screen within a predetermine time after the return from the first power saving mode or the second power saving mode to the executable mode, not regard the return as the apparatus's execution of a process, and not record the mode for the return in the history.

9. A non-transitory computer-readable storage medium storing a program for causing a computer to execute a process comprising:
for an apparatus having a plurality of modes having different times until execution of a process is ready,
determining a mode that is to be recorded in a history as a mode at a time of execution of a process, the determining being performed based on a mode at the time of the apparatus's execution of the process and whether the process is performed based on a human detecting sensor's detection of a user;
recording the determined mode in the history; and
outputting a set value of a shift time elapsing until the apparatus shifts to a mode in which a time until execution of a process is ready is longer than in another mode among the plurality of modes, the outputting being performed based on a count of processes performed in a specific mode, the count of processes being obtained based on the history.

10. A method for an apparatus having a plurality of modes having different times until execution of a process is ready, the method comprising:
determining a mode that is to be recorded in a history as a mode at a time of execution of a process, the determining being performed based on a mode at the time of the apparatus's execution of the process and whether the process is performed based on a human detecting sensor's detection of a user;
recording the determined mode in the history; and
outputting a set value of a shift time elapsing until the apparatus shifts to a mode in which a time until execution of a process is ready is longer than in another mode among the plurality of modes, the outputting being performed based on a count of processes performed in a specific mode, the count of processes being obtained based on the history.
